(19) United States
(12) Patent Application Publication
(10) Pub. No.: US 2019/0176684 A1
(43) Pub. Date: Jun. 13, 2019

(54) Location Based Vehicle Headlight Control

(71) Applicant: Uber Technologies, Inc., San Francisco, CA (US)

(72) Inventor: Noah Zych, Pittsburgh, PA (US)

(21) Appl. No.: 15/907,906

(22) Filed: Feb. 28, 2018

Related U.S. Application Data
(60) Provisional application No. 62/595,906, filed on Dec. 7, 2017.

(51) Int. Cl. B60Q 1/08; B60Q 1/00; B60Q 1/14; B60W 30/095; G06K 9/00

(52) U.S. Cl. CPC B60Q 1/085; B60Q 1/0023; G06K 9/00805; B60W 30/0956; G06K 9/00798; B60Q 1/1423

(57) ABSTRACT

Systems, methods, tangible non-transitory computer-readable media, and devices for operating an autonomous vehicle are provided. For example, a method can include receiving sensor data based at least in part on sensor outputs from sensors of an autonomous vehicle. The sensor outputs can be based at least in part on a state of the autonomous vehicle and an environment including one or more objects. A plurality of spatial relations can be determined based on the sensor data. The plurality of spatial relations can include the position of the autonomous vehicle with respect to the one or more objects. A headlight configuration for headlights of the autonomous vehicle can be determined, based on the plurality of spatial relations. The headlight configuration can specify headlight states for each of the headlights. A set of the one or more headlights can be activated, based on the headlight configuration.

### RELATED APPLICATION

The present application is based on and claims benefit of U.S. Provisional Patent Application No. 62/595,906 having a filing date of Dec. 7, 2017, which is incorporated by reference herein.

### FIELD

The present disclosure relates generally to operation of an autonomous vehicle including the configuration and control of lights associated with the autonomous vehicle.

### BACKGROUND

Vehicles, including autonomous vehicles, can include a variety of vehicle systems that are used to perform different functions associated with operation of the vehicle. The vehicle systems can include various electric and mechanical systems that allow a vehicle to operate more efficiently in its environment. However, the environment in which a vehicle operates is not static and improvements in vehicle safety and performance can be more readily achieved when the vehicle systems adapt to the environment. Accordingly, there exists a need for an autonomous vehicle that is able to more effectively control and configure its vehicle systems, thereby improving the operational efficiency and safety of the vehicle.

### SUMMARY

Aspects and advantages of embodiments of the present disclosure will be set forth in part in the following description, or may be learned from the description, or may be learned through practice of the embodiments.

An example aspect of the present disclosure is directed to a computer-implemented method of operating an autonomous vehicle. The computer-implemented method of autonomous vehicle operation includes receiving, by a computing system including one or more computing devices, sensor data based at least in part on one or more sensor outputs from one or more sensors of an autonomous vehicle. The one or more sensor outputs are based at least in part on a state of the autonomous vehicle and an environment including one or more objects. The method includes determining, by the computing system, based at least in part on the sensor data, a plurality of spatial relations including the position of the autonomous vehicle with respect to the one or more objects. The method also includes determining, by the computing system, based at least in part on the plurality of spatial relations, a headlight configuration for one or more headlights of the autonomous vehicle. The headlight configuration specifies one or more headlight states for each of the one or more headlights. Further, the method includes activating, by the computing system, a set of the one or more headlights based at least in part on the headlight configuration.

Another example aspect of the present disclosure is directed to a computing system, that includes one or more processors; a machine-learned object detection model trained to receive sensor data and, responsive to receiving the sensor data, generate an output including one or more detected object predictions and a headlight configuration based at least in part on the one or more detected object predictions; a memory including one or more computer-readable media. The memory stores computer-readable instructions that when executed by the one or more processors cause the one or more processors to perform operations. The operations include receiving sensor data from one or more sensors associated with an autonomous vehicle. The sensor data includes information associated with a set of physical dimensions of one or more objects. The operations include sending the sensor data to the machine-learned object detection model. The operations also include generating, based at least in part on the output from the machine-learned object detection model, one or more detected object predictions including one or more identities associated with the one or more objects. Further, the operations include generating, based at least in part on the one or more identities associated with the one or more object predictions, a headlight configuration associated with one or more states of one or more headlights of an autonomous vehicle.

Another example aspect of the present disclosure is directed to an autonomous vehicle including one or more processors and a memory including one or more computer-readable media. The memory can store computer-readable instructions that when executed by the one or more processors can cause the one or more processors to perform operations. The operations include receiving sensor data based at least in part on one or more sensor outputs from one or more sensors of an autonomous vehicle. The one or more sensor outputs are based at least in part on a state of the autonomous vehicle and an environment including one or more objects. The operations include determining, based at least in part on the sensor data and a machine-learned model, a plurality of spatial relations and one or more object classifications corresponding to the one or more objects. The plurality of spatial relations include a distance between the autonomous vehicle and each of the one or more objects. The operations include determining, based at least in part on the plurality of spatial relations or the one or more object classifications, a headlight configuration for one or more headlights of the autonomous vehicle. The headlight configuration specifies one or more headlight states for each of the one or more headlights.

Other example aspects of the present disclosure are directed to other systems, methods, vehicles, apparatuses, tangible non-transitory computer-readable media, and devices for operation of an autonomous vehicle including determination of a headlight configuration for the autonomous vehicle.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example system according to example embodiments of the present disclosure;

FIG. 2 depicts an example of an environment including a vehicle determining headlight configuration on a curved road according to example embodiments of the present disclosure;

FIG. 3 depicts an example of an environment including a vehicle determining headlight configuration at an intersection according to example embodiments of the present disclosure;

FIG. 4 depicts an example of an environment including a vehicle determining headlight configuration in a pick-up area according to example embodiments of the present disclosure;

FIG. 5 depicts an example of an environment including vehicles exchanging headlight configuration data according to example embodiments of the present disclosure;

FIG. 6 depicts a flow diagram of an example method of autonomous vehicle operation according to example embodiments of the present disclosure;

FIG. 7 depicts a flow diagram of an example method of autonomous vehicle operation according to example embodiments of the present disclosure;

FIG. 8 depicts a flow diagram of an example method of autonomous vehicle operation according to example embodiments of the present disclosure;

FIG. 9 depicts a flow diagram of an example method of autonomous vehicle operation according to example embodiments of the present disclosure;

FIG. 10 depicts a flow diagram of an example method of autonomous vehicle operation according to example embodiments of the present disclosure; and

FIG. 11 depicts an example system according to example embodiments of the present disclosure.

### DETAILED DESCRIPTION

Example aspects of the present disclosure are directed to configuring and activating headlights of a vehicle (e.g., an autonomous vehicle, a semi-autonomous vehicle, or a manually operated vehicle). In particular, aspects of the present disclosure include a computing system (e.g., a vehicle computing system including one or more computing devices configured to control one or more vehicle systems) that can generate a headlight configuration (e.g., a data structure that includes information associated with a set of states for one or more headlights) and activate headlights of a vehicle based at least in part on the state of the vehicle, the state of the environment proximate to the vehicle, and/or a travel path of the vehicle.

By way of example, the computing system can receive sensor data from one or more sensors (e.g., one or more cameras to detect the environment outside the vehicle and one or more internal sensors to detect the internal state of the vehicle) of a vehicle travelling on a road. The one or more sensors can detect one or more objects which the computing system determines to be, for example, a set of buildings and two pedestrians. For example, the computing system can use one or more object recognition techniques including the use of a machine-learned model to determine the identities of the one or more objects. Based on the sensor data used to detect the set of buildings and the two vehicles, the computing system can determine a plurality of spatial relations including the distances between the vehicle, the set of buildings, and the two pedestrians. Further, the computing system can use the plurality of spatial relations to generate a data structure that includes a headlight configuration.

The headlight configuration can specify the state of each of the one or more headlights including an intensity of light emitted by the headlights, whether a headlight is on or off, a target area or location or light emitted by a headlight, and/or a position and/or angle of a headlight. Based on the headlight configuration, the computing system can activate one or more headlights. For example, the headlight configuration can be used to lower the intensity of light emitted by the headlights when the vehicle is within thirty meters of either one of the pedestrians. By adjusting the headlight configuration based at least in part on the environment around a vehicle, the vehicle computing system is able to more effectively activate one or more headlights, thereby conserving resources (e.g., battery resources and/or fuel resources), improving headlight longevity, improving safety (e.g., adjusting headlights to avoid temporarily blinding oncoming drivers), and increasing the comfort of pedestrians (e.g., reducing excessively bright headlights) and others outside the vehicle. Furthermore, adjustment of the headlight configuration can be used to signal and/or communicate an action and/or event (e.g., a current or planned action and/or event by the vehicle). For example, the vehicle computing system can adjust the headlight configuration (e.g., change the headlight configuration to flash lights in a specified pattern on the right side of a vehicle) to communicate a planned path of the vehicle (e.g., that the vehicle will be turning right within a predetermined period of time or at the next intersection). By way of further example, the vehicle computing system can adjust the headlight configuration of a vehicle that is merging onto a highway to indicate that the vehicle will yield right of way to other vehicles that are already traveling on the highway.

The disclosed technology can include a vehicle computing system (e.g., one or more computing devices that includes one or more processors and a memory) that can process, generate, and/or exchange (e.g., send and/or receive) signals or data, including signals or data exchanged with various devices including one or more vehicles, vehicle components (e.g., one or more headlights), and/or remote computing devices. For example, the vehicle computing system can exchange signals (e.g., electronic signals) or data with vehicle systems including illumination systems (e.g., headlights, internal lights, signal lights, and/or tail lights); sensor systems (e.g., sensors that generate output based on the state of the physical environment external to the vehicle, including one or more light detection and ranging (LIDAR) devices, cameras, microphones, radar devices, and/or sonar devices); communication systems (e.g., wired or wireless communication systems that can exchange signals or data with other devices); navigation systems (e.g., devices that can receive signals from GPS, GLONASS, or other systems used to determine a vehicle's geographical location); notification systems (e.g., devices used to provide notifications to waiting passengers, including one or more display devices, status indicator lights, or audio output systems); braking systems (e.g., brakes of the vehicle including mechanical and/or electric brakes); propulsion systems (e.g., motors or engines including internal combustion engines or electric engines); and/or steering systems used to change the path, course, or direction of travel of the vehicle.

The vehicle computing system can receive sensor data based at least in part on one or more sensor outputs from one or more sensors of an autonomous vehicle. The one or more sensor outputs can be based at least in part on a state of the autonomous vehicle and an environment (e.g., an area within a predetermined distance of the autonomous vehicle) that includes one or more objects (e.g., vehicles, buildings, and/or pedestrians). The state of the autonomous vehicle can include a velocity of the autonomous vehicle, an acceleration of the autonomous vehicle, a geographical location of the autonomous vehicle, or a trajectory of the autonomous vehicle.

The one or more sensors can be configured to detect the state of the environment including the one or more objects. The state of the environment can include physical characteristics of the environment including temperature, pressure, size (e.g., one or more physical dimensions), shape, texture, and or color. The one or more sensors can include one or more cameras, one or more sonar devices, one or more radar devices, LIDAR devices, one or more thermal sensors, one or more audio sensors, one or more tactile sensors, one or more humidity sensors, one or more pressure sensors, and/or one or more barometric pressure sensors.

The vehicle computing system can determine, based at least in part on the sensor data, a plurality of spatial relations that include the position of the autonomous vehicle with respect to the one or more objects. For example, the vehicle computing system can determine the distance between the autonomous vehicle and each of the one or more objects. Further, the autonomous vehicle can determine the geometry of the road, buildings, and geographic features of the environment being traversed by the autonomous vehicle.

The vehicle computing system can determine, based at least in part on the plurality of spatial relations, a headlight configuration for one or more headlights of the autonomous vehicle. The headlight configuration can specify one or more headlight states for each of the one or more headlights. The headlight configuration can be associated with one or more physical or electrical characteristics of each of the one or more headlights. The one or more headlight states can include an on state (e.g., a headlight is turned on), an off state (e.g., a headlight is turned off), a target illumination region (e.g., an area or location external to the vehicle that light emitted by the headlight is directed towards), a horizontal angle (e.g., a horizontal angle of a headlight with respect to the ground), a vertical angle (e.g., a vertical angle of a headlight with respect to the ground), a height (e.g., a height of a headlight with respect to a surface of the autonomous vehicle), an intensity of emitted light (e.g., the brightness of light produced by a headlight), or a color of emitted light.

The vehicle computing system can activate a set of the one or more headlights based at least in part on the headlight configuration. Based on the headlight configuration, the vehicle computing system can send one or more signals (e.g., electronic signals) to one or more vehicle systems associated with operation of the one or more headlights. For example, the vehicle computing system can activate each of the one or more headlights specified in the headlight configuration at a particular intensity of emitted light.

The vehicle computing system can determine, based at least in part on the plurality of spatial relations, an object proximity distance including a distance between the autonomous vehicle and one of the one or more objects that is closest to the autonomous vehicle. For example, the plurality of spatial relations can include distances between an autonomous vehicle and three objects, and can select the shortest distance. Further, the vehicle computing system can determine, based at least in part on the object proximity distance, an intensity of emitted light for at least one of the one or more headlights. For example, the intensity of emitted light can be proportional to the object proximity distance (e.g., the headlights can be dimmed as the distance between the autonomous vehicle and an object decreases). In some embodiments, determining the headlight configuration can include determining, based at least in part on the object proximity distance, an intensity of emitted light for at least one of the one or more headlights.

The vehicle computing system can determine, based at least in part on path data or the sensor data, a predicted path of the autonomous vehicle. The path data can include information associated with a plurality of locations for the autonomous vehicle to traverse. The plurality of locations can include a current location of the autonomous vehicle and a destination location. For example, the path data can include a path for the autonomous vehicle that is determined by the vehicle computing system based at least in part on perception (e.g., the autonomous vehicle's perception of the environment based at least in part on the sensor data), prediction (e.g., a prediction of the future locations of the one or more objects in the environment), and planning (e.g., planning a path of the autonomous vehicle to a destination so that the autonomous vehicle avoids contact with the one or more objects) by the vehicle computing system. In some embodiments determining the headlight configuration can include determining the headlight configuration based at least in part on the predicted path of the autonomous vehicle.

The vehicle computing system can determine, based at least in part on the plurality of spatial relations, one or more path characteristics of a predicted path of the autonomous vehicle, the one or more path characteristics including a path angle (e.g., an angle of the path being traversed by the autonomous vehicle), a path grade (e.g., a slope or gradient of the path being traversed by the autonomous vehicle), or an intersection proximity (e.g., a distance between the autonomous vehicle and an intersection on the path being traversed by the autonomous vehicle). For example, the vehicle computing system can determine that an intersection is within one hundred meters of the autonomous vehicle and can generate a headlight configuration in which the intensity of light emitted state is set to an intermediate level that is bright enough for incoming vehicles to anticipate the autonomous vehicle (e.g., but not so bright as to temporarily blind incoming drivers). In some embodiments determining the headlight configuration can include determining the headlight configuration based at least in part on the one or more path characteristics.

The vehicle computing system can determine, based at least in part on the sensor data, one or more predicted object paths of the one or more objects. The one or more predicted object paths can include a plurality of locations that each of the one or more objects is predicted to traverse in a plurality time intervals. For example, the one or more predicted object paths can be determined based at least in part on perception (e.g., the autonomous vehicle's perception of the state of the one or more objects based at least in part on the sensor data) and prediction (e.g., a prediction of the future locations, velocities, and/or orientations of the one or more objects in the environment) by the vehicle computing system. In some embodiments determining the headlight configuration can include determining the one or more predicted object paths of the one or more objects.

The vehicle computing system can determine, based at least in part on the sensor data, a location of one or more reflective surfaces in the environment. For example, the vehicle computing system can use sensor data including one or more images captured by one or more image sensors (e.g., one or more cameras) to determine the one or more surfaces in the one or more images that are reflective (e.g., the surfaces that include reflections of the autonomous vehicle or the environment). In some embodiments determining the headlight configuration can include determining the location of the one or more reflective surfaces.

The vehicle computing system can receive external vehicle configuration data associated with a location, a velocity, a travel path, external vehicle sensor outputs, or an external vehicle headlight configuration of one or more vehicles in the environment. For example, one or more vehicles in the environment can transmit (e.g., wirelessly transmit) one or more signals including the external vehicle configuration data that can be received by one or more other vehicles including the autonomous vehicle. In this way, by sharing headlight configurations among multiple vehicles, coordinated headlight configuration adjustment is enabled and facilitated. In some embodiments determining the headlight configuration can include determining the external vehicle configuration data.

The vehicle computing system can receive map data that includes information associated with a plurality of locations or geographical features in the environment. For example, the autonomous vehicle can receive the map data via one or more signals transmitted from a remote computing device and/or one or more other vehicles. The plurality of locations or geographical features can include one or more school locations, one or more residential locations, one or more commercial locations, one or more wildlife locations, one or more tollbooth locations, one or more bridges, one or more tunnels, and/or one or more overpasses. In some embodiments determining the plurality of spatial relations can include determining the plurality of spatial relations based at least in part on the map data.

The vehicle computing system can determine, based at least in part on map data, one or more pick-up areas or drop-off areas in the environment. The pick-up areas and the drop-off areas can include areas in which the autonomous vehicle can respectively pick-up or drop-off passengers. Further, the vehicle computing system can determine an intensity of emitted light for the one or more headlights based at least in part on a distance of the autonomous vehicle from the one or more pick-up areas or drop-off areas. For example, as the autonomous vehicle approaches or enters a pick-up area or a drop-off area, the intensity of emitted light for the one or more headlights can be reduced, thereby avoiding casting high intensity light in the eyes of waiting passengers. In some embodiments determining the headlight configuration can include determining the headlight configuration based at least in part on the intensity of emitted light for the one or more headlights.

In some embodiments, the vehicle computing system can include a machine-learned object detection model that is trained to receive sensor data and, in response to receiving the sensor data, generate output that includes one or more detected object predictions and a headlight configuration based at least in part on the one or more detected object predictions. Further, the vehicle computing system can receive sensor data from one or more sensors associated with an autonomous vehicle. The sensor data can include information associated with a set of physical dimensions of one or more objects (e.g., vehicles, buildings, and/or pedestrians within range of the autonomous vehicle's sensors).

The sensor data can be sent to the machine-learned object detection model which can process the sensor data and generate an output (e.g., classified sensor outputs). The vehicle computing system can generate, based at least in part on output from the machine-learned object detection model, one or more detected object predictions that include one or more identities (e.g., identifying vehicles, buildings, and/or pedestrians) associated with the one or more objects. Further, the vehicle computing system can generate, based at least in part on output from the machine-learned object detection model, a headlight configuration (e.g., a data structure that includes information associated with the state of headlights) associated with one or more states of one or more headlights of an autonomous vehicle.

In some embodiments, the vehicle computing system can generate headlight configuration output that is based at least in part on the one or more detected object predictions. The headlight configuration output can include one or more signals (e.g., electronic signals including data associated with the headlight configuration) to one or more vehicle systems including one or more headlights and/or other lighting systems of the vehicle.

The vehicle computing system can access a machine-learned model that has been generated and/or trained in part using training data including a plurality of classified features and a plurality of classified object labels. In some embodiments, the plurality of classified features can be extracted from point cloud data that includes a plurality of three-dimensional points associated with sensor output including output from one or more sensors (e.g., one or more LIDAR devices). Further, the plurality of classified features can be extracted from one or more images each of which include a representation of one or more objects in which the representation is based at least in part on output from one or more image sensor devices (e.g., one or more cameras).

When the machine-learned model has been trained, the machine-learned model can associate the plurality of classified features with one or more classified object labels that are used to classify or categorize objects including objects that are not included in the plurality of training objects (e.g., a type of car that is not included in the plurality of training objects can be recognized as a car using the machine-learned model). In some embodiments, as part of the process of training the machine-learned model, the differences in correct classification output between a machine-learned model (that outputs the one or more classified object labels) and a set of classified object labels associated with a plurality of training objects that have previously been correctly identified (e.g., ground truth labels), can be processed using an error loss function that can determine a set of probability distributions based on repeated classification of the same plurality of training objects. As such, the effectiveness (e.g., the rate of correct identification of objects) of the machine-learned model can be improved over time.

The vehicle computing system can access the machine-learned model in a variety of ways including exchanging (sending and/or receiving via a network) data or information associated with a machine-learned model that is stored on a remote computing device; and/or accessing a machine-learned model that is stored locally (e.g., in one or more storage devices of the vehicle).

The plurality of classified features can be associated with one or more values that can be analyzed individually and/or in various aggregations. Analysis of the one or more values associated with the plurality of classified features can include determining a mean, mode, median, variance, standard deviation, maximum, minimum, and/or frequency of the one or more values associated with the plurality of classified features. Further, analysis of the one or more values associated with the plurality of classified features can include comparisons of the differences or similarities between the one or more values. For example, the one or more objects associated with pedestrian can be associated with a range of sizes, shapes, and/or velocities that are different from the range of sizes, shapes, and/or velocities associated with a cyclist.

In some embodiments, the plurality of classified features can include a range of velocities associated with the plurality of training objects, a range of colors associated with the plurality of training objects, a range of shapes associated with the plurality of training objects, a length of the plurality of training objects, a width of the plurality of training objects, and/or a height of the plurality of training objects. The plurality of classified features can be based at least in part on the output from one or more sensors that have captured a plurality of training objects (e.g., actual objects used to train the machine-learned model) from various angles and/or distances in different environments (e.g., urban areas, suburban areas, rural areas, heavy traffic, and/or light traffic) and/or environmental conditions (e.g., bright daylight, rainy days, darkness, snow covered roads, inside parking garages, in tunnels, and/or under streetlights). The one or more classified object labels, which can be used to classify or categorize the one or more objects, can include buildings, roads, city streets, highways, sidewalks, bridges, overpasses, waterways, pedestrians, automobiles, trucks, cyclists, or wildlife.

The machine-learned model can be generated based at least in part on one or more classification processes or classification techniques. The one or more classification processes or classification techniques can include one or more computing processes performed by one or more computing devices based at least in part on sensor data associated with physical outputs from a sensor device. The one or more computing processes can include the classification (e.g., allocation or sorting into different groups or categories) of the physical outputs from the sensor device, based at least in part on one or more classification criteria (e.g., a size, shape, color, velocity, acceleration, and/or sound associated with an object). In some embodiments, the machine-learned object detection model can include a convolutional neural network, a recurrent neural network, a recursive neural network, gradient boosting, a support vector machine, or a logistic regression classifier.

In some embodiments, the vehicle computing system can determine, based at least in part on the sensor data and a machine-learned model, a plurality of spatial relations and one or more object classifications corresponding to the one or more objects. For example, the plurality of spatial relations can include a distance between the autonomous vehicle and each of the one or more objects. The one or more object classifications corresponding to the one or more objects can include one or more vehicles, one or more pedestrians, one or more cyclists, wildlife, one or more buildings, one or more reflective surfaces, and/or one or more utility structures.

Further, in some embodiments, the vehicle computing system can generate, based at least in part on the plurality of spatial relations and/or the one or more object classifications, a headlight configuration for one or more headlights of the autonomous vehicle. For example, based on the determination that the one or more objects include a person in a tollbooth, the vehicle computing system can generate a headlight configuration in which the state of the headlights includes a reduced intensity of light emitted by the headlights.

The vehicle computing system can determine, based at least in part on the sensor data and/or the one or more object classifications, one or more predicted object paths of the one or more objects. The one or more predicted object paths can include a plurality of locations that each of the one or more objects is predicted to traverse in a plurality time intervals. For example, the vehicle computing system can detect two objects, and determine object classifications for the two objects (e.g., the first object is a cyclist and that the second object is a pedestrian). Based on the determination that the two objects are a cyclist and a pedestrian, the vehicle computing system can determine a maximum velocity range for each of the two objects and thereby more accurately determine the path of each of the two objects. In some embodiments the headlight configuration can be based at least in part on the one or more predicted paths of the one or more objects.

The systems, methods, and devices in the disclosed technology can provide a variety of technical effects and benefits. In particular, the disclosed technology can provide numerous benefits including improvements in the areas of safety, energy efficiency, headlight longevity, passenger and pedestrian comfort, vehicle system performance, and more optimal energy resource utilization. For example, the disclosed technology can improve the operational safety of a vehicle by determining a more effective headlight configuration for headlights of an autonomous vehicle. By generating a headlight configuration that specifies the set of activated headlights as well as other states of the headlights including the intensity of light emitted by the headlights, the disclosed technology can adjust the vehicle's headlights to avoid temporarily blinding a driver of an oncoming vehicle and/or disrupting the operation of one or more sensors of an oncoming vehicle.

For example, excessively intense light emitted by a set of headlights can disrupt the operation of image sensors of an oncoming autonomous vehicle, thereby negatively impacting the quality of sensor outputs generated by the image sensors. As a result, the disclosed technology can result in an improvement in the operation of a perception system of an oncoming autonomous vehicle that relies on sensor outputs. When the disclosed technology adjusts its headlights according to a headlight configuration that has less negative impact on image sensors (e.g., reducing the intensity of light emitted by the headlights and/or aiming the headlights away from an oncoming autonomous vehicle), an oncoming vehicle's sensors and/or perception system can operate more effectively.

Further, by more optimally activating the headlights of an autonomous vehicle, the disclosed technology can improve the performance of the autonomous vehicle's own sensors and perception system by emitting light in a way that more clearly illuminates objects in an environment traversed by the autonomous vehicle. Additionally, as a result of improved sensor and/or perception system performance, other vehicle systems can be used more optimally. For example, improved sensor and perception system performance can result in more accurate detection of an environment which can allow more fine-grained adjustment of acceleration, steering, and acceleration, and as a result less wear and tear on vehicle components (e.g., brakes and/or steering components) due to fewer incidences of sudden course corrections due to lower quality sensor outputs.

Further, the disclosed technology can improve the longevity of the vehicle's headlights by adjusting the headlight configuration so that headlights of the vehicle are selectively activated or deactivated and emit light at various levels of intensity. In this way, the headlights are adjusted based on the particular conditions in an environment and not haphazardly activated such that an excessive number of headlights are activated and/or the headlights emit light at an excessively high level of intensity. In addition to improving the longevity of the vehicle's headlights, the disclosed technology can improve the utilization of energy resources (e.g., battery and/or fuel resources) by using the headlights in a way that does not excessively tax the energy resources.

Furthermore, the disclosed technology can improve the safety of passengers by generating a headlight configuration that is better adapted to the environment in which the autonomous vehicle is travelling. The disclosed technology can determine when the autonomous vehicle is approaching an area in which high intensity headlights would cause discomfort to one or more people and adjust the intensity of the headlights accordingly. For example, the disclosed technology can reduce the intensity of the headlights when the autonomous vehicle approaches a tollbooth or a group of passengers waiting to be picked up by the autonomous vehicle. Further, by generating a headlight configuration based at least in part on the environment traversed by the vehicle, passengers of an autonomous vehicle or a driver of a non-autonomous vehicle can enjoy the benefits of an improved view that results from more optimally adjusted headlights.

Accordingly, the disclosed technology can provide more effective configuration and activation of a vehicle's headlights through improvements in operational efficiency, passenger safety, pedestrian comfort, and battery resources as well as allowing for improved performance of other vehicle systems that benefit from more optimal lighting conditions.

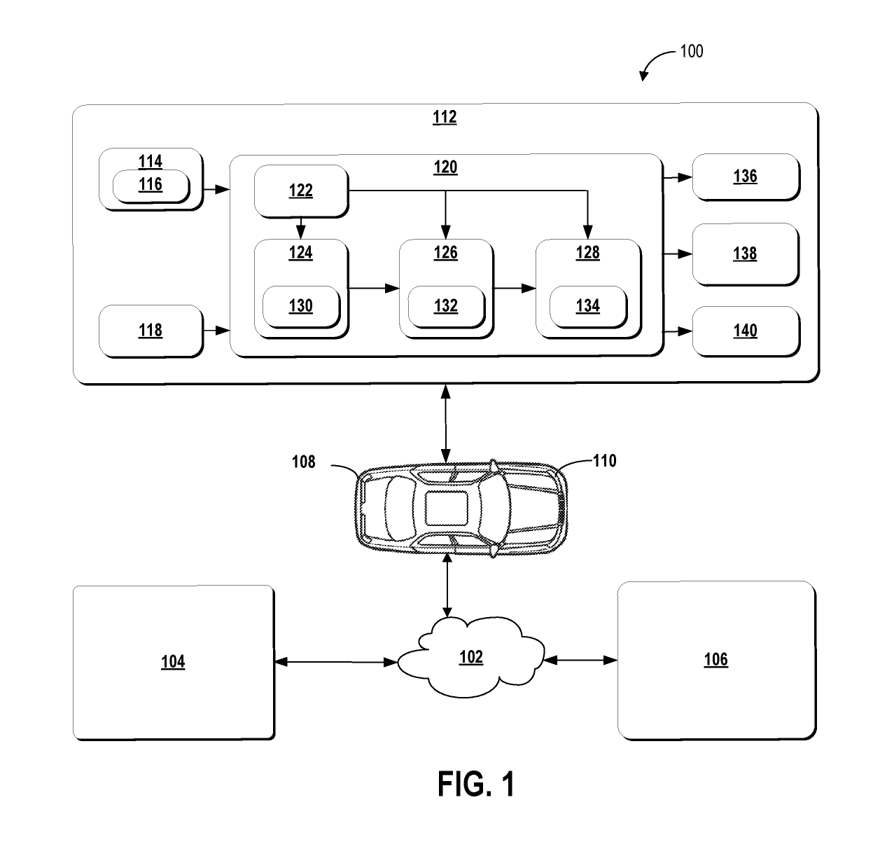

With reference now to FIGS. 1-11, example embodiments of the present disclosure will be discussed in further detail. FIG. 1 depicts a diagram of an example system 100 according to example embodiments of the present disclosure. As illustrated, FIG. 1 shows a system 100 that includes a communication network 102; an operations computing system 104; one or more remote computing devices 106; a vehicle 108; one or more headlights 110; a vehicle computing system 112; one or more sensors 114; sensor data 116; a positioning system 118; an autonomy computing system 120; map data 122; a perception system 124; a prediction system 126; a motion planning system 128; state data 130; prediction data 132; motion plan data 134; a communication system 136; a vehicle control system 138; and a human-machine interface 140.

The operations computing system 104 can be associated with a service provider that can provide one or more vehicle services to a plurality of users via a fleet of vehicles that includes, for example, the vehicle 108. The vehicle services can include transportation services (e.g., rideshare services), courier services, delivery services, and/or other types of services.

The operations computing system 104 can include multiple components for performing various operations and functions. For example, the operations computing system 104 can include and/or otherwise be associated with the one or more computing devices that are remote from the vehicle 108. The one or more computing devices of the operations computing system 104 can include one or more processors and one or more memory devices. The one or more memory devices of the operations computing system 104 can store instructions that when executed by the one or more processors cause the one or more processors to perform operations and functions associated with operation of a vehicle including receiving sensor data from a vehicle (e.g., the vehicle 108), determining a plurality of spatial relations of the vehicle with respect to an environment, determining a headlight configuration for the vehicle, and/or activating one or more vehicle systems including one or more headlights of the vehicle.

For example, the operations computing system 104 can be configured to monitor and communicate with the vehicle 108 and/or its users to coordinate a vehicle service provided by the vehicle 108. To do so, the operations computing system 104 can manage a database that includes data including vehicle status data associated with the status of vehicles including the vehicle 108. The vehicle status data can include a location of a vehicle (e.g., a latitude and longitude of a vehicle), the availability of a vehicle (e.g., whether a vehicle is available to pick-up or drop-off passengers and/or cargo), or the state of objects external to a vehicle (e.g., the physical dimensions and/or appearance of objects external to the vehicle).

The operations computing system 104 can communicate with the one or more remote computing devices 106 and/or the vehicle 108 via one or more communications networks including the communications network 102. The communications network 102 can exchange (send or receive) signals (e.g., electronic signals) or data (e.g., data from a computing device) and include any combination of various wired (e.g., twisted pair cable) and/or wireless communication mechanisms (e.g., cellular, wireless, satellite, microwave, and radio frequency) and/or any desired network topology (or topologies). For example, the communications network 102 can include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 108. Further, the operations computing system 104 can be used to exchange and/or communicate data (e.g., sensor data and/or data associated with a headlight configuration) between vehicles including the vehicle 108 and/or other vehicles that communicate via the operations computing system 104. For example, the vehicle 108 can, in response to detecting wildlife (e.g., deer) in an area traveled by the vehicle 108, send data (e.g., data including a headlight configuration, the area where the wildlife were detected, and/or the time at which the wildlife were detected) to other vehicles via the operations computing system 104. As a result, when other vehicles enter the area that was traveled by the vehicle 108, the other vehicles can adjust their headlight configuration in accordance with the headlight configuration in the data sent by the vehicle 108 (e.g., adjust headlight configuration when traveling in the area within a predetermined time interval of the time of day when wildlife was detected).

Each of the one or more remote computing devices 106 can include one or more processors and one or more memory devices. The one or more memory devices can be used to store instructions that when executed by the one or more processors of the one or more remote computing devise 106 cause the one or more processors to perform operations and/or functions including operations and/or functions associated with the vehicle 108 including exchanging (e.g., sending and/or receiving) data or signals with the vehicle 108, monitoring the state of the vehicle 108, and/or controlling the vehicle 108. The one or more remote computing devices 106 can communicate (e.g., exchange data and/or signals) with one or more devices including the operations computing system 104 and the vehicle 108 via the communications network 102. For example, the one or more remote computing devices 106 can request the location of the vehicle 108 via the communications network 102. The one or more remote computing devices 106 can include one or more computing devices (e.g., a desktop computing device, a laptop computing device, a smart phone, and/or a tablet computing device) that can receive input or instructions from a user or exchange signals or data with an item or other computing device or computing system (e.g., the operations computing system 104). Further, the one or more remote computing devices 106 can be used to determine and/or modify one or more states of the vehicle 108 including a location (e.g., a latitude and longitude), a velocity, acceleration, a trajectory, and/or a path of the vehicle 108 based in part on signals or data exchanged with the vehicle 108. In some implementations, the operations computing system 104 can include the one or more remote computing devices 106.

The vehicle 108 can be a ground-based vehicle (e.g., an automobile), an aircraft, and/or another type of vehicle. The vehicle 108 can be an autonomous vehicle that can perform various actions including driving, navigating, and/or operating, with minimal and/or no interaction from a human driver. The autonomous vehicle 108 can be configured to operate in one or more modes including, for example, a fully autonomous operational mode, a semi-autonomous operational mode, a park mode, and/or a sleep mode. A fully autonomous (e.g., self-driving) operational mode can be one in which the vehicle 108 can provide driving and navigational operation with minimal and/or no interaction from a human driver present in the vehicle. A semi-autonomous operational mode can be one in which the vehicle 108 can operate with some interaction from a human driver present in the vehicle. Park and/or sleep modes can be used between operational modes while the vehicle 108 performs various actions including waiting to provide a subsequent vehicle service, and/or recharging between operational modes.

Furthermore, the vehicle 108 can include the one or more headlights 110 which can include one or more devices that can emit, generate, and/or produce light including one or more lamps, lighting devices, and/or headlamps. The one or more headlights 110 can be based in part on different types of lighting technology including one or more light emitting diodes (LEDs), fluorescent light devices, incandescent light devices, halogen light devices, xenon arc lamp devices, metal-halide lamp devices, halogen lamp devices, and/or neon lamp devices.

An indication, record, and/or other data indicative of a headlight configuration and/or the state of an environment including one or more objects (e.g., the physical dimensions and/or appearance of the one or more objects) can be stored locally in one or more memory devices of the vehicle 108. Furthermore, the vehicle 108 can provide data indicative of the state of the one or more objects (e.g., physical dimensions and/or appearance of the one or more objects) within a predefined distance of the vehicle 108 to the operations computing system 104, which can store an indication, record, and/or other data indicative of the state of the one or more objects within a predefined distance of the vehicle 108 in one or more memory devices associated with the operations computing system 104 (e.g., remote from the vehicle).

The vehicle 108 can include and/or be associated with the vehicle computing system 112. The vehicle computing system 112 can include one or more computing devices located onboard the vehicle 108. For example, the one or more computing devices of the vehicle computing system 112 can be located on and/or within the vehicle 108. The one or more computing devices of the vehicle computing system 112 can include various components for performing various operations and functions. For instance, the one or more computing devices of the vehicle computing system 112 can include one or more processors and one or more tangible, non-transitory, computer readable media (e.g., memory devices). The one or more tangible, non-transitory, computer readable media can store instructions that when executed by the one or more processors cause the vehicle 108 (e.g., its computing system, one or more processors, and other devices in the vehicle 108) to perform operations and functions, including those described herein for determining user device location data and controlling the vehicle 108 with regards to the same.

As depicted in FIG. 1, the vehicle computing system 112 can include the one or more sensors 114; the positioning system 118; the autonomy computing system 120; the communication system 136; the vehicle control system 138; and the human-machine interface 140. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can exchange (e.g., send and/or receive) data, messages, and/or signals amongst one another via the communication channel.

The one or more sensors 114 can be configured to generate and/or store data including the sensor data 116 associated with one or more objects that are proximate to the vehicle 108 (e.g., within range or a field of view of one or more of the one or more sensors 114). The one or more sensors 114 can include a Light Detection and Ranging (LIDAR) system, a Radio Detection and Ranging (RADAR) system, one or more cameras (e.g., visible spectrum cameras and/or infrared cameras), motion sensors, and/or other types of imaging capture devices and/or sensors. The sensor data 116 can include image data, radar data, LIDAR data, and/or other data acquired by the one or more sensors 114. The one or more objects can include, for example, pedestrians, vehicles, bicycles, and/or other objects. The one or more objects can be located on various parts of the vehicle 108 including a front side, rear side, left side, right side, top, or bottom of the vehicle 108. The sensor data 116 can be indicative of locations associated with the one or more objects within the surrounding environment of the vehicle 108 at one or more times. For example, sensor data 116 can be indicative of one or more LIDAR point clouds associated with the one or more objects within the surrounding environment. The one or more sensors 114 can provide the sensor data 116 to the autonomy computing system 120.

In addition to the sensor data 116, the autonomy computing system 120 can retrieve or otherwise obtain data including the map data 122. The map data 122 can provide detailed information about the surrounding environment of the vehicle 108. For example, the map data 122 can provide information regarding: the identity and location of different roadways, road segments, buildings, or other items or objects (e.g., lampposts, crosswalks and/or curb); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); and/or any other map data that provides information that assists the vehicle computing system 112 in comprehending and perceiving its surrounding environment and its relationship thereto.

The vehicle computing system 112 can include a positioning system 118. The positioning system 118 can determine a current position of the vehicle 108. The positioning system 118 can be any device or circuitry for analyzing the position of the vehicle 108. For example, the positioning system 118 can determine position by using one or more of inertial sensors, a satellite positioning system, based on IP/MAC address, by using triangulation and/or proximity to network access points or other network components (e.g., cellular towers and/or Wi-Fi access points) and/or other suitable techniques. The position of the vehicle 108 can be used by various systems of the vehicle computing system 112 and/or provided to one or more remote computing devices (e.g., the operations computing system 104 and/or the remote computing device 106). For example, the map data 122 can provide the vehicle 108 relative positions of the surrounding environment of the vehicle 108. The vehicle 108 can identify its position within the surrounding environment (e.g., across six axes) based at least in part on the data described herein. For example, the vehicle 108 can process the sensor data 116 (e.g., LIDAR data, camera data) to match it to a map of the surrounding environment to get an understanding of the vehicle's position within that environment (e.g., transpose the vehicle's position within its surrounding environment).

The autonomy computing system 120 can include a perception system 124, a prediction system 126, a motion planning system 128, and/or other systems that cooperate to perceive the surrounding environment of the vehicle 108 and determine a motion plan for controlling the motion of the vehicle 108 accordingly. For example, the autonomy computing system 120 can receive the sensor data 116 from the one or more sensors 114, attempt to determine the state of the surrounding environment by performing various processing techniques on the sensor data 116 (and/or other data), and generate an appropriate motion plan through the surrounding environment. The autonomy computing system 120 can control the one or more vehicle control systems 138 to operate the vehicle 108 according to the motion plan.

The autonomy computing system 120 can identify one or more objects that are proximate to the vehicle 108 based at least in part on the sensor data 116 and/or the map data 122. For example, the perception system 124 can obtain state data 130 descriptive of a current and/or past state of an object that is proximate to the vehicle 108. The state data 130 for each object can describe, for example, an estimate of the object's current and/or past: location and/or position; speed; velocity; acceleration; heading; orientation; size/footprint (e.g., as represented by a bounding shape); class (e.g., pedestrian class vs. vehicle class vs. bicycle class), and/or other state information. The perception system 124 can provide the state data 130 to the prediction system 126 (e.g., for predicting the movement of an object).

The prediction system 126 can generate prediction data 132 associated with each of the respective one or more objects proximate to the vehicle 108. The prediction data 132 can be indicative of one or more predicted future locations of each respective object. The prediction data 132 can be indicative of a predicted path (e.g., predicted trajectory) of at least one object within the surrounding environment of the vehicle 108. For example, the predicted path (e.g., trajectory) can indicate a path along which the respective object is predicted to travel over time (and/or the velocity at which the object is predicted to travel along the predicted path). The prediction system 126 can provide the prediction data 132 associated with the one or more objects to the motion planning system 128.

The motion planning system 128 can determine a motion plan and generate motion plan data 134 for the vehicle 108 based at least in part on the prediction data 132 (and/or other data). The motion plan data 134 can include vehicle actions with respect to the objects proximate to the vehicle 108 as well as the predicted movements. For instance, the motion planning system 128 can implement an optimization algorithm that considers cost data associated with a vehicle action as well as other objective functions (e.g., cost functions based on speed limits, traffic lights, and/or other aspects of the environment), if any, to determine optimized variables that make up the motion plan data 134. By way of example, the motion planning system 128 can determine that the vehicle 108 can perform a certain action (e.g., pass an object) without increasing the potential risk to the vehicle 108 and/or violating any traffic laws (e.g., speed limits, lane boundaries, signage). The motion plan data 134 can include a planned trajectory, velocity, acceleration, and/or other actions of the vehicle 108.

The motion planning system 128 can provide the motion plan data 134 with data indicative of the vehicle actions, a planned trajectory, and/or other operating parameters to the vehicle control systems 138 to implement the motion plan data 134 for the vehicle 108. For instance, the vehicle 108 can include a mobility controller configured to translate the motion plan data 134 into instructions. By way of example, the mobility controller can translate a determined motion plan data 134 into instructions for controlling the vehicle 108 including adjusting the steering of the vehicle 108 “X” degrees and/or applying a certain magnitude of braking force. The mobility controller can send one or more control signals to the responsible vehicle control component (e.g., braking control system, steering control system and/or acceleration control system) to execute the instructions and implement the motion plan data 134.

The vehicle computing system 112 can include a communications system 136 configured to allow the vehicle computing system 112 (and its one or more computing devices) to communicate with other computing devices. The vehicle computing system 112 can use the communications system 136 to communicate with the operations computing system 106 and/or one or more other remote computing devices (e.g., the one or more remote computing devices 106) over one or more networks (e.g., via one or more wireless signal connections). In some implementations, the communications system 136 can allow communication among one or more of the system on-board the vehicle 108. The communications system 136 can also be configured to enable the autonomous vehicle to communicate with and/or provide and/or receive data and/or signals from a remote computing device 106 associated with a user and/or an item (e.g., an item to be picked-up for a courier service). The communications system 136 can utilize various communication technologies including, for example, radio frequency signaling and/or Bluetooth low energy protocol. The communications system 136 can include any suitable components for interfacing with one or more networks, including, for example, one or more: transmitters, receivers, ports, controllers, antennas, and/or other suitable components that can help facilitate communication. In some implementations, the communications system 136 can include a plurality of components (e.g., antennas, transmitters, and/or receivers) that allow it to implement and utilize multiple-input, multiple-output (MIMO) technology and communication techniques.

The vehicle computing system 112 can include the one or more human-machine interfaces 140. For example, the vehicle computing system 112 can include one or more display devices located on the vehicle computing system 112. A display device (e.g., screen of a tablet, laptop and/or smartphone) can be viewable by a user of the vehicle 108 that is located in the front of the vehicle 108 (e.g., driver's seat, front passenger seat). Additionally, or alternatively, a display device can be viewable by a user of the vehicle 108 that is located in the rear of the vehicle 108 (e.g., a back passenger seat).

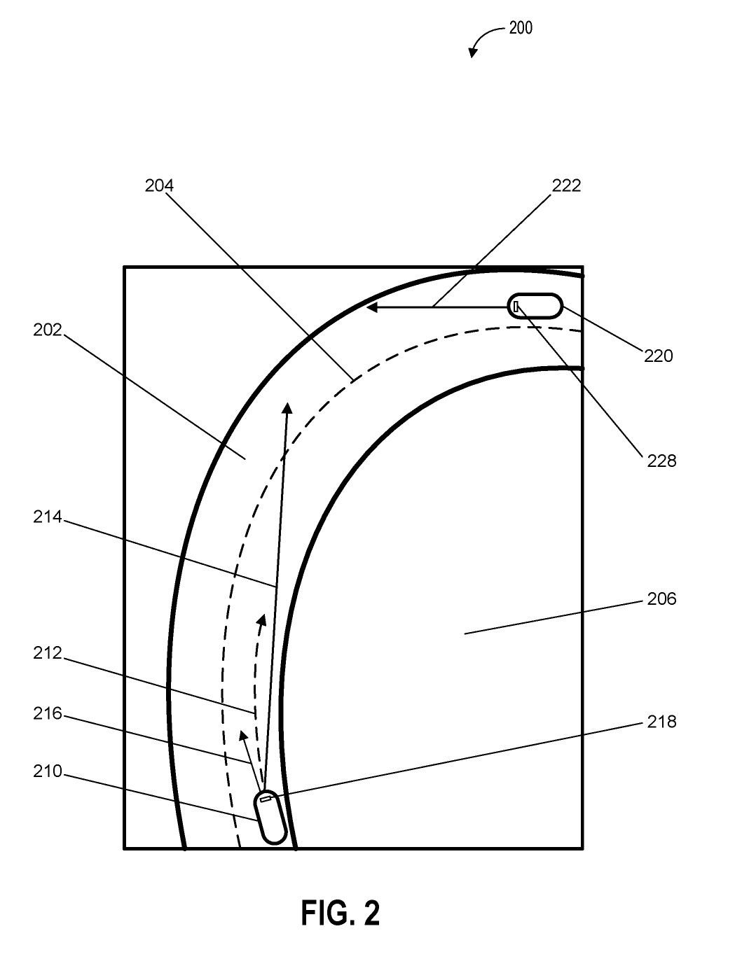

FIG. 2 depicts an example of an environment including a vehicle determining headlight configuration on a curved road according to example embodiments of the present disclosure. One or more actions or events depicted in FIG. 2 can be implemented by one or more devices (e.g., one or more computing devices) or systems (e.g., one or more computing systems) including, for example, the operations computing system 104, the vehicle 108, or the vehicle computing system 112, shown in FIG. 1. As illustrated, FIG. 2 shows an environment 200 that includes a road 202, a lane marker 204, a hillside 206, a vehicle 210, a path 212, a headlight beam path 214, a headlight beam path 216, one or more headlights 218, a vehicle 220, a path 222, and one or more headlights 228.

In this example, the vehicle 210 (e.g., an autonomous vehicle) is travelling on the road 202 (e.g., a rural road) along the path 212 (e.g., a current travel path). The vehicle 210 can include the one or more headlights 218 which can include one or more devices that can emit, generate, and/or produce light including one or more lamps, lighting devices, and/or headlamps. The one or more headlights 218 can be based on different types of lighting technology including one or more light emitting diodes (LEDs), fluorescent light devices, incandescent light devices, halogen light devices, xenon arc lamp devices, metal-halide lamp devices, halogen lamp devices, and/or neon lamp devices. Further, the one or more headlights 218 can be located at various portions of the vehicle 210 including at a front side (e.g., the side of the vehicle 210 that is in front of the passengers as the vehicle travels forward), left side (e.g., a driver side), right side (e.g., a passenger side), top side (e.g., a roof of the vehicle 210), bottom side (e.g., an undercarriage of the vehicle 210), and/or rear side (e.g., the side of the vehicle 210 that is behind the passengers as the vehicle travels in reverse). Further, the one or more headlights of the vehicle 210 can be configured according to a headlight configuration which can be generated by one or more computing devices or computing systems associated with the vehicle 210 (e.g., a headlight configuration computing device in the vehicle 210 that can activate and adjust the position of headlights in the vehicle 210).

The vehicle 210 can include one or more headlights that are positioned throughout the vehicle 210 and which can be powered on, powered down, dimmed, intensified (e.g., brighter headlights), and or have the color of the one or more headlights changed based on the headlight configuration. A position of each of the one or more headlights 218 can be modified including lowering, raising, tilting up, tilting down, tilting left, and/or tilting right.

In this example, the vehicle 210 and the vehicle 220 are travelling in different directions on opposite sides of the lane marker 204 on the road 202. As the vehicle 210 and the vehicle 220 are being operated at night, both the vehicle 210 and the vehicle 220 have activated their respective headlights (e.g., the vehicle 210 has activated the one or more headlights 218 and the vehicle 220 has activated the one or more headlights 228). Further, the hillside 206 blocks a portion of the light emitted by the one or more headlights 218 of the vehicle 210 and the one or more headlights 228 of the vehicle 220.

As the vehicle 210 turns along the road 202, the vehicle 210 can determine, based on one or more sensor outputs from one or more sensors (e.g., one or more cameras, LIDAR, sonar, and/or radar devices) included in the vehicle 210 or associated with the vehicle 210 the location, velocity, and/or trajectory of the vehicle 220. Further, the vehicle 210 can determine, based in part on the sensor outputs from the one or more sensors, various properties of the light produced by headlights of the vehicle 220 including light that illuminates the path 222 traveled by the vehicle 220. For example, the vehicle 220 can determine a direction and an intensity of light produced by headlights of the vehicle 220.

In some embodiments, the vehicle 210 can determine the location, velocity, and/or trajectory of the vehicle 220 based in part on navigational data (e.g., navigational data and/or map data that includes a map of the environment 200), which can be received from an external source including one or more remote computing devices.

In response to the vehicle 210 detecting the vehicle 220 and determining the path 222 of the vehicle 220 and properties of the headlight beams produced by the vehicle 220, the vehicle 210 can generate a headlight configuration that can be used to change the position of the one or more headlights of the vehicle 210 from illuminating a path in the direction of the headlight beam path 216 to illuminating in the direction of the headlight beam path 214. In this way, the one or more headlights of the vehicle 210 can be configured to more effectively illuminate a travel path of the vehicle 210 in accordance with the contours of the road 202 and the location of the vehicle 220.

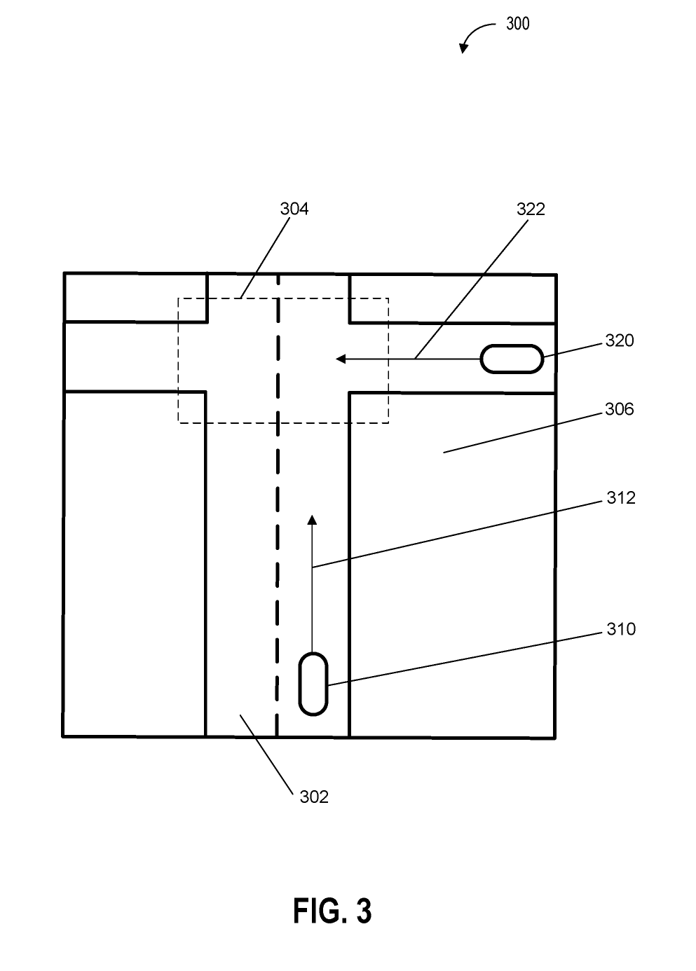

FIG. 3 depicts an example of an environment including a vehicle determining headlight configuration at an intersection according to example embodiments of the present disclosure. One or more actions or events depicted in FIG. 3 can be implemented by one or more devices (e.g., one or more computing devices) or systems (e.g., one or more computing systems) including, for example, the operations computing system 104, the vehicle 108, or the vehicle computing system 112, shown in FIG. 1. As illustrated, FIG. 3 shows an environment 300 that includes a road 302, an intersection area 304, a building 306, a vehicle 310, a path 312, a vehicle 320, and a path 322.

In this example, the vehicle 310 (e.g., an autonomous vehicle) is travelling on the road 302 (e.g., a suburban street) along the path 312 (e.g., a current travel path). The vehicle 310 can include one or more headlights (not shown), that in have been activated due to the heavy fog in the environment 300 and that can be positioned at various locations on the vehicle 310 including at a front side (e.g., the side of the vehicle 310 that is in front of the passengers as the vehicle travels forward), left side (e.g., a driver side), right side (e.g., a passenger side), top side (e.g., a roof of the vehicle 310), bottom side (e.g., an undercarriage of the vehicle 310), and/or rear side (e.g., the side of the vehicle 310 that is behind the passengers as the vehicle travels in reverse). Further, the one or more headlights of the vehicle 310 can be configured according to a headlight configuration which can be generated by one or more computing devices or computing systems associated with the vehicle 310 (e.g., a headlight configuration computing device in the vehicle 310 that can activate and adjust the position of headlights in the vehicle 310).

The vehicle 310 can include one or more headlights that are positioned throughout the vehicle 310 and which can be powered on, powered down, dimmed, intensified (e.g., brighter headlights), and or have the color of the one or more headlights changed based on the headlight configuration. Further, a position of each of the one or more headlights can be modified (e.g., lowering, raising, tilting up, tilting down, tilting left, and/or tilting right of the one or more headlights).

In this example, the vehicle 310 and the vehicle 320 (which has also activated its headlights due to the heavy fog conditions in the environment 300) are travelling on the road 302 towards the intersection area 304. The building 306 blocks some of the light produced by the headlights of the vehicle 310 and the vehicle 320. The vehicle 310 can determine, based on one or more sensor outputs from one or more sensors (e.g., one or more cameras, LIDAR, sonar, and/or radar devices) and/or navigational data (e.g., navigational data and/or map data that includes a map of the environment 300), the location, velocity, and/or trajectory of the vehicle 320. Further, the vehicle can determine, based on sensor outputs from the one or more sensors, various properties of the light produced by headlights of the vehicle 320 including light that illuminates the path 322 traveled by the vehicle 320. In this example, the vehicle 310 can detect light produced by the vehicle 320 as the vehicle 310 and the vehicle 320 approach the intersection area 304. Further, the vehicle 310 can estimate the proximity of the vehicle 320 based in part on the intensity of the detected light from the vehicle 320.

In response to the vehicle 310 detecting the vehicle 320 and determining the path 322 of the vehicle 320 and properties of the headlight beams produced by the vehicle 320, the vehicle 310 can generate a headlight configuration that can be used to change the intensity of the one or more headlights of the vehicle 310. In this way, for example, the one or more headlights of the vehicle 310 can be configured to shine at a lower intensity as the vehicle 310 approaches the intersection area 304. As such, by lowering the headlight intensity, the vehicle 310 can convey passengers more safely by reducing the intensity of light in intersections (e.g., the intersection area 304).

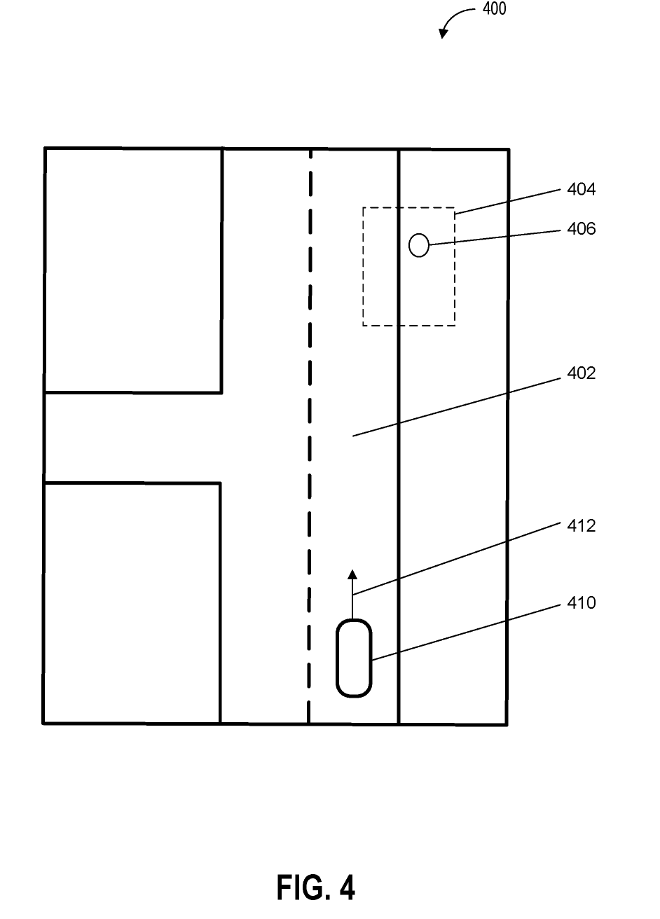

FIG. 4 depicts an example of an environment including a vehicle determining headlight configuration in a pick-up area according to example embodiments of the present disclosure. One or more actions or events depicted in FIG. 4 can be implemented by one or more devices (e.g., one or more computing devices) or systems (e.g., one or more computing systems) including, for example, the operations computing system 104, the vehicle 108, or the vehicle computing system 112, shown in FIG. 1. As illustrated, FIG. 4 shows an environment 400 that includes a road 402, a pick-up area 404, a passenger 406, a vehicle 410, and a path 412.

In this example, the vehicle 410 (e.g., an autonomous vehicle) is travelling on the road 402 (e.g., a city street) along the path 412 (e.g., a current travel path). The vehicle 410 can include one or more headlights (not shown) that can be positioned at various locations on the vehicle 410 including at a front side (e.g., the side of the vehicle 410 that is in front of the passengers as the vehicle travels forward), left side (e.g., a driver side), right side (e.g., a passenger side), top side (e.g., a roof of the vehicle 410), bottom side (e.g., an undercarriage of the vehicle 410), and/or rear side (e.g., the side of the vehicle 410 that is behind the passengers as the vehicle travels in reverse). Further, the one or more headlights of the vehicle 410 can be configured according to a headlight configuration that can be generated by one or more computing devices or computing systems associated with the vehicle 410 (e.g., a headlight configuration computing device in the vehicle 410 that can activate and adjust the position of headlights in the vehicle 410). The environment 400 is experiencing heavy rainfall, and accordingly, the vehicle 410 has activated its headlights to better illuminate the portions of the environment 400 that are proximate to the vehicle 410.

The vehicle 410 can include one or more headlights that are positioned throughout the vehicle 410 and which can be powered on, powered down, dimmed, intensified (e.g., brighter headlights), and or have the color of the one or more headlights changed based on the headlight configuration. Further, a position of each of the one or more headlights can be modified (e.g., lowering, raising, tilting up, tilting down, tilting left, and/or tilting right of the one or more headlights).

In this example, the vehicle 410 is travelling on the road 402 towards the pick-up area 404 at which a passenger 406 is waiting for the vehicle 410 to arrive. The vehicle 410 can determine, based on one or more sensor outputs from one or more sensors (e.g., one or more cameras, LIDAR, sonar, and/or radar devices) and/or navigational data (e.g., navigational data and/or map data that includes a map of the environment 400), a distance between the vehicle 410, the pick-up area 404, and the passenger 406.

In response to the vehicle 410 detecting the pick-up area 404 and the passenger 406, the vehicle 410 can generate a headlight configuration that can be used to change the intensity of the one or more headlights of the vehicle 410. In this example, the one or more headlights of the vehicle 410 can be configured to shine at a lower intensity as the vehicle 410 approaches the pick-up area 404. As such, by lowering the headlight intensity, the vehicle 410 can improve the experience of the passenger 406 by avoiding shining a bright headlight in the eyes of the passenger 406. Further, as the vehicle 410 leaves the pick-up area 404 with the passenger 406 aboard, the vehicle 410 can adjust the headlight configuration to provide the passenger 406 with an illuminated view of the environment 400 which is darkened, thereby promoting a greater sense of passenger comfort for the passenger 406.

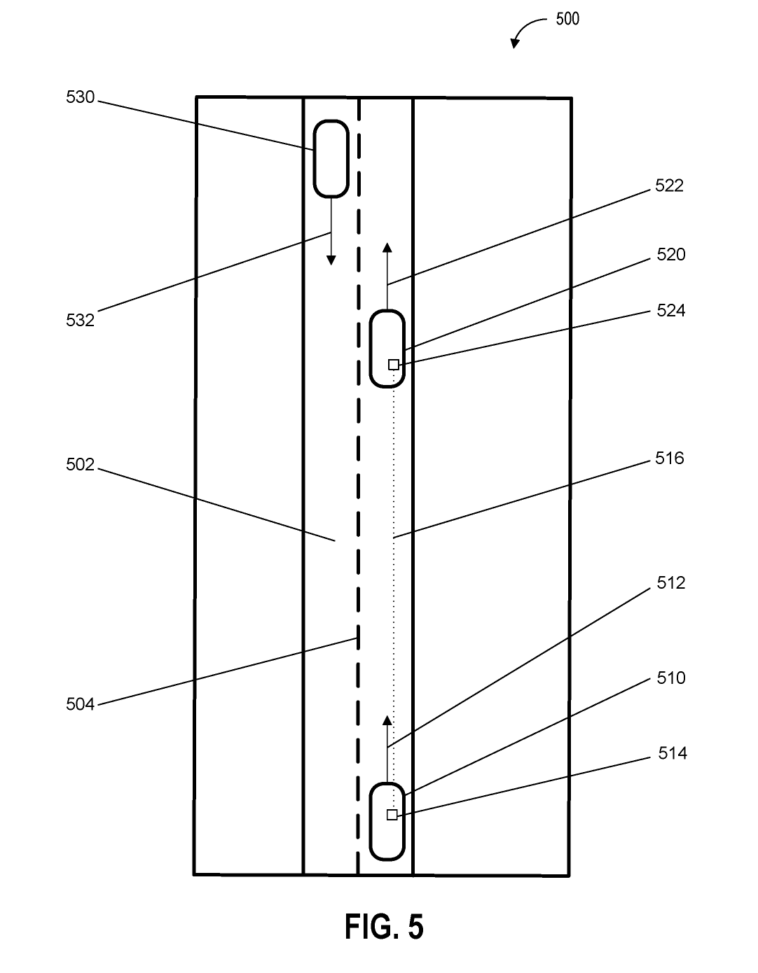

FIG. 5 depicts an example of an environment including vehicles exchanging headlight configuration data according to example embodiments of the present disclosure. One or more actions or events depicted in FIG. 5 can be implemented by one or more devices (e.g., one or more computing devices) or systems (e.g., one or more computing systems) including, for example, the operations computing system 104, the vehicle 108, or the vehicle computing system 112, shown in FIG. 1. As illustrated, FIG. 5 shows an environment 500 that includes a road 502, a lane marker 504, a vehicle 510, a path 512, a communication device 514, a signal 516 (e.g., a headlight configuration signal), a vehicle 520, a path 522, a communication device 524, a vehicle 530, and a path 532.

In this example, the vehicle 510 (e.g., an autonomous vehicle) is travelling on the road 502 (e.g., a highway) along the path 512 (e.g., a current travel path). The vehicle 510 can include one or more headlights (not shown) that can be positioned at various locations on the vehicle 510 including at a front side (e.g., the side of the vehicle 510 that is in front of the passengers as the vehicle travels forward), left side (e.g., a driver side), right side (e.g., a passenger side), top side (e.g., a roof of the vehicle 510), bottom side (e.g., an undercarriage of the vehicle 510), and/or rear side (e.g., the side of the vehicle 510 that is behind the passengers as the vehicle travels in reverse). Further, the one or more headlights of the vehicle 510 can be configured according to a headlight configuration which can be generated by one or more computing devices or computing systems associated with the vehicle 510 (e.g., a headlight configuration computing device in the vehicle 510 that can activate and adjust the position of headlights in the vehicle 510).

The vehicle 510 can include one or more headlights that are positioned throughout the vehicle 510 and which can be powered on, powered down, dimmed, intensified (e.g., brighter headlights), and or have the color of the one or more headlights changed based on the headlight configuration. Further, a position of each of the one or more headlights can be modified (e.g., lowering, raising, tilting up, tilting down, tilting left, and/or tilting right of the one or more headlights).

As shown, the vehicle 510 is travelling in the same direction and behind the vehicle 520, which is travelling along the path 522. Further, the vehicle 510 and the vehicle 520 are travelling in a different direction from the vehicle 530, which is travelling along the path 532 on the opposite side of the lane marker 504. As illustrated in FIG. 5, the vehicle 510 and the vehicle 520 include the communication device 514 and the communication device 524 respectively. The communication device 514 and the communication device 524 can be used to exchange (e.g., send and/or receive) one or more signals or data with the other one of the communication device 514 and the communication device 524. In this example, the vehicle 520 can detect the vehicle 530 and properties associated with the vehicle 530 including the velocity, path, trajectory, and headlight brightness of the vehicle 530. The vehicle 520 can send one or more signals or data to the vehicle 510 via the signal 516 which is transmitted by the communication device 524 and received by the communication device 514 of the vehicle 510.

In response to the vehicle 510 receiving the one or more signals or data from the vehicle 520, the vehicle 510 can generate a headlight configuration that can be used to change the intensity of the one or more headlights of the vehicle 510 as the vehicle 510 approaches the vehicle 530. In this way, for example, the one or more headlights of the vehicle 510 can be configured to shine at a lower intensity as the vehicle 510 approaches the vehicle 520. As such, by lowering the headlight intensity, the vehicle 510 can improve safety by reducing the incidence of overexposing optical sensors of the vehicle 530 and thereby allowing the vehicle 530 to more accurately determine the state of the environment. Further, the vehicle 510 can improve the comfort of passengers travelling in the vehicle 530 by reducing the intensity of light that is emitted in the direction of the vehicle 530.

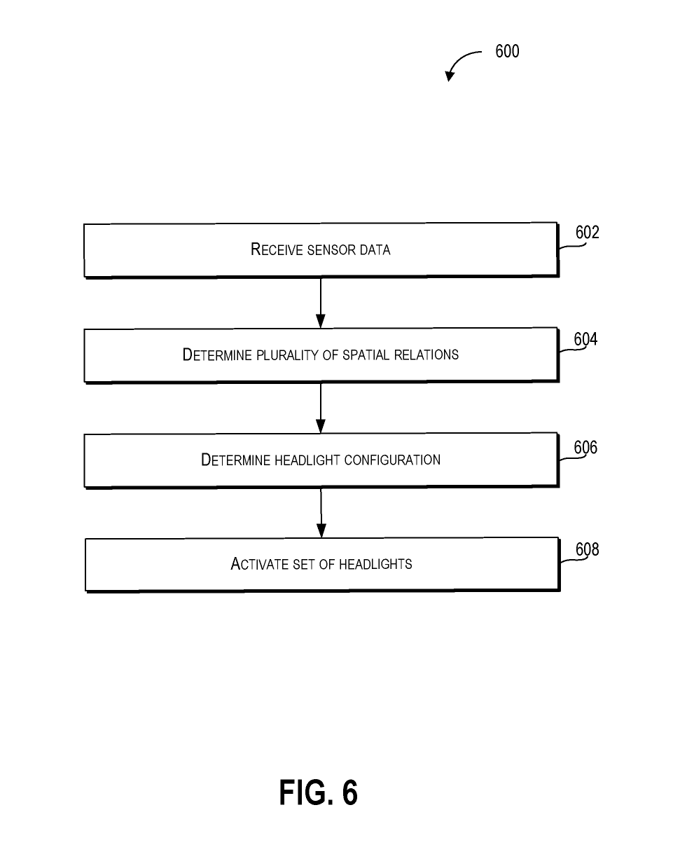

FIG. 6 depicts a flow diagram of an example method of autonomous vehicle operation according to example embodiments of the present disclosure. One or more portions of a method 600 can be implemented by one or more devices (e.g., one or more computing devices) or systems including, for example, the operations computing system 104, the vehicle 108, or the vehicle computing system 112, shown in FIG. 1. Moreover, one or more portions of the method 600 can be implemented as an algorithm on the hardware components of the devices described herein (e.g., as in FIG. 1) to, for example, determine a headlight configuration for a vehicle. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 602, the method 600 can include receiving sensor data (e.g., the sensor data 116 from the one or more sensors 114). The sensor data can be based at least in part on one or more sensor outputs from one or more sensors of a vehicle (e.g., the vehicle 108). The one or more sensor outputs can be based at least in part on a state of the vehicle and an environment including one or more objects. For example, a vehicle can receive sensor data from one or more image sensors (e.g., one or more cameras on the front and rear of the vehicle, which can be used to determine the location of one or more objects detectable (e.g., visible to) the one or more image sensors. In some embodiments, the sensor data can include sensor data received from one or more sensors that are remote from the vehicle. For example, the sensor data can include sensor data from one or more traffic light cameras, user devices (e.g., smartphones), and/or other vehicles (e.g., sensor data from cameras of other vehicles).

The state of the vehicle can include at least one of a velocity of the vehicle, an acceleration of the vehicle, a geographical location (e.g., a latitude and longitude, address, or landmark identity) of the vehicle, orientation, bearing, and/or a trajectory of the vehicle. The one or more sensors can include at least one of one or more cameras, one or more sonar devices, one or more radar devices, one or more light detection and ranging (LIDAR) devices, one or more thermal sensors, one or more audio sensors, one or more tactile sensors, one or more humidity sensors, one or more pressure sensors, and/or one or more barometric pressure sensors.

At 604, the method 600 can include determining a plurality of spatial relations including the position of the vehicle with respect to the one or more objects. The plurality of spatial relations can be determined based at least in part on the sensor data. For example, the distance and/or angle between the vehicle and each of the one or more objects can be determined. Further, the vehicle can determine physical dimensions (e.g., height, width, and/or depth) of the one or more objects as well as the geometry of roads, buildings, and geographic features (e.g., natural features including mountains, rivers, and/or forests) of the environment being traversed by the vehicle.

At 606, the method 600 can include determining a headlight configuration for one or more headlights (e.g., the one or more headlights 110) of the vehicle (e.g., the vehicle 108). The headlight configuration can be based at least in part on the plurality of spatial relations. The headlight configuration can specify one or more headlight states for each of the one or more headlights. In some embodiments, the headlight configuration can be stored in one or more memory devices that include one or more datasets or data structures associated with the headlight configuration and which can be retrieved for later use by the vehicle.

The one or more headlight states can include at least one of an on state (e.g., a headlight is powered on), an off state (e.g., a headlight is powered down), a target illumination region and/or a target illumination area (e.g., a position or area to which light from a headlight is directed, including for example, a location to which light from the headlight can be directed without changing the physical position of the headlight), a horizontal angle (e.g., an angle with respect to an x axis parallel to a surface of the vehicle or the ground beneath the vehicle), a vertical angle (e.g., an angle with respect to a y axis perpendicular to a surface of the vehicle or the ground beneath the vehicle), a height (e.g., a height of a headlight relative to the ground beneath the vehicle), an intensity of emitted light (e.g., a luminous intensity, radiant intensity, and/or irradiance of the light produces by a headlight), and/or a color of emitted light.

At 608, the method 600 can include activating a set of the one or more headlights. Activating the set of the one or more headlights can be based at least in part on the headlight configuration. For example, a headlight configuration data object can indicate that two of a vehicle's front headlights are to be activated at maximum intensity. Based in part on receiving one or more signals or data that include the headlight configuration data object, the vehicle can activate the two front headlights at maximum intensity (e.g., by sending one or more control signals to one or more controllers configured to activate the one or more headlights).

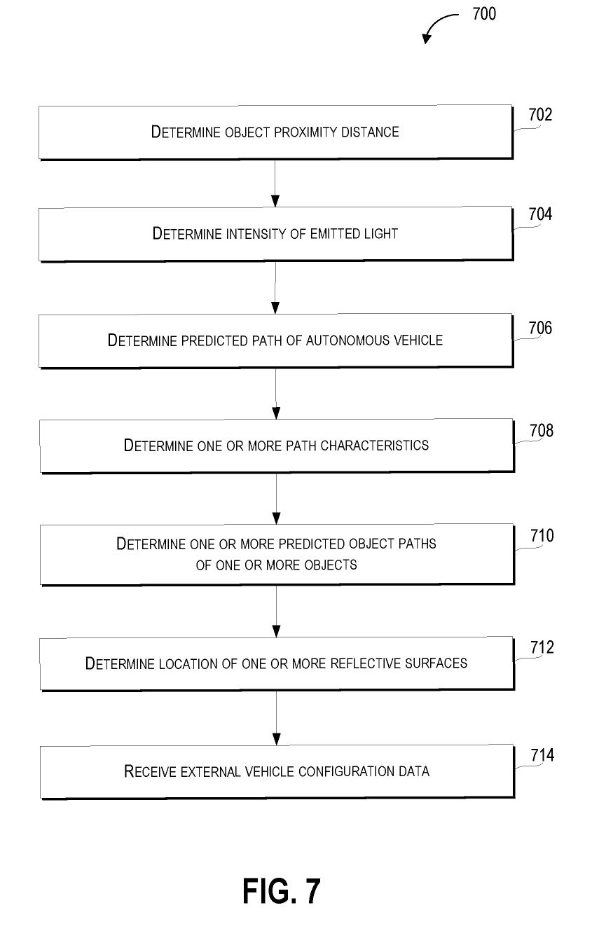

FIG. 7 depicts a flow diagram of an example method of autonomous vehicle operation according to example embodiments of the present disclosure. One or more portions of a method 700 can be implemented by one or more devices (e.g., one or more computing devices) or systems including, for example, the operations computing system 104, the vehicle 108, or the vehicle computing system 112, shown in FIG. 1. Moreover, one or more portions of the method 700 can be implemented as an algorithm on the hardware components of the devices described herein (e.g., as in FIG. 1) to, for example, determine a headlight configuration for a vehicle. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 702, the method 700 can include determining an object proximity distance including a distance between the vehicle (e.g., the vehicle 108) and one of the one or more objects (e.g., the one or more objects in the method 600) that is closest to the vehicle. The object proximity distance can be determined based at least in part on the plurality of spatial relations. For example, the plurality of spatial relations can include distances between a vehicle and a plurality of other vehicles (e.g., two vehicles, three vehicles, four vehicles, or five vehicles), and can select the shortest distance. In some embodiments, the object proximity distance between the vehicle and the one or more objects can be restricted to objects that are within a height range or height threshold of the vehicle. By way of example only, a vehicle that is ten meters above the vehicle (e.g., a vehicle that is on an overpass above the vehicle) can exceed a seven meter height threshold and may not be used in the determination of the distance that is closest to the vehicle.

At 704, the method 700 can include determining, based at least in part on the object proximity distance, an intensity of emitted light for at least one of the one or more headlights (e.g., the one or more headlights 110). In some embodiments, the intensity of emitted light can be proportional to the object proximity distance. For example, the intensity of emitted light can be inversely proportional to the object proximity distance (e.g., the intensity of light emitted by the headlights can be increased as the distance between the vehicle and an object increases). In some embodiments, determining the headlight configuration (e.g., the headlight configuration in the method 600) can include determining, based at least in part on the object proximity distance, an intensity of emitted light for at least one of the one or more headlights (e.g., the one or more headlights in the method 600).

At 706, the method 700 can include determining, based at least in part on path data or the sensor data (e.g., the sensor data 116 from the one or more sensors 114), a predicted path of the vehicle. The path data can include information associated with a plurality of locations for the vehicle to traverse. The plurality of locations can include a current location (e.g., a current latitude and longitude) of the vehicle and a destination location (e.g., a latitude and longitude to which the vehicle will travel).

For example, the path data can include a path for the vehicle that is determined by an autonomy computing system of the vehicle which can receive one or more inputs or instructions including the current location and a destination location for the vehicle. Based on the least in part on the sensor data and/or the path data a perception system, a prediction system, and a planning system of the autonomy system can be used to determine a path to the destination location. In some embodiments, determining the headlight configuration can include determining the headlight configuration based at least in part on the predicted path of the vehicle. The path can include a vehicle route determined (e.g., by the vehicle computing system 112 and/or the operations computing system 104) based at least in part on an origin destination and/or a destination location. Additionally, or alternatively, the path can include one or more motion trajectories (e.g., of a motion plan) determined by the vehicle computing system 112 (e.g., the onboard motion planning system 128).

At 708, the method 700 can include determining one or more path characteristics of the predicted path of the vehicle. Determining the one or more path characteristics of the predicted path of the vehicle can be based at least in part on the plurality of spatial relations. The one or more path characteristics can include at least one of a path angle (e.g., a horizontal or left to right angle of the path being traversed by the vehicle), a path grade (e.g., the steepness of the path), and/or an intersection proximity (e.g., the distance to the nearest intersection along the path traversed by the vehicle). For example, a vehicle can travel along a path that will pass through a blind turn (e.g., the vehicle is partly or wholly occluded from being visible to oncoming vehicles or pedestrians until it is in the process of navigating the blind turn) in fifty meters and can generate a headlight configuration in which the intensity of light emitted state is set to an intermediate level that is bright enough for incoming vehicles to anticipate the vehicle (e.g., but not bright enough to temporarily blind incoming drivers or startle wildlife). In some embodiments, determining the headlight configuration can include determining the headlight configuration based at least in part on the one or more path characteristics.

At 710, the method 700 can include determining, based at least in part on the sensor data, one or more predicted object paths of the one or more objects. The one or more predicted object paths can include a plurality of locations that each of the one or more respective objects is determined to traverse. For example, the one or more predicted object paths can be determined at least in part by a computing system of the vehicle that can calculate paths that the one or more objects will travel including paths that can result in the one or more objects that can intersect the vehicle. In some embodiments determining the headlight configuration can include determining the one or more predicted object paths of the one or more objects. In some embodiments, determining the headlight configuration can include determining the headlight configuration based at least in part on the one or more predicted object paths of the one or more objects.

At 712, the method 700 can include determining a location of one or more reflective surfaces in the environment. Determining the location of the one or more reflective surfaces in the environment can be based at least in part on the sensor data. The one or more reflective surfaces can include one or more surfaces that reflect an amount of light that is above a predetermined reflectivity threshold level. For example, a mirror or a polished silver cup can exceed a predetermined reflectivity threshold. In contrast a brown brick wall may not exceed the predetermined reflectivity threshold and will not be classified as a reflective surface. For example, the sensor data including one or more images captured by one or more image sensors (e.g., one or more cameras) can be used to determine the one or more surfaces in the one or more images that are reflective (e.g., the surfaces that include reflections of the vehicle's headlights). In some embodiments, determining the headlight configuration can include determining the headlight configuration based at least in part on the location of the one or more reflective surfaces.

At 714, the method 700 can include receiving external vehicle configuration data associated with at least one of a location, a velocity, a travel path, external vehicle sensor outputs, and/or an external vehicle headlight configuration of one or more vehicles in the environment. For example, one or more vehicles in the environment can transmit (e.g., wirelessly transmit) and/or receive (e.g., receive by a wireless receiver) one or more signals that include the external vehicle configuration data. In some embodiments, determining the headlight configuration can include determining the headlight configuration based at least in part on the external vehicle configuration data.

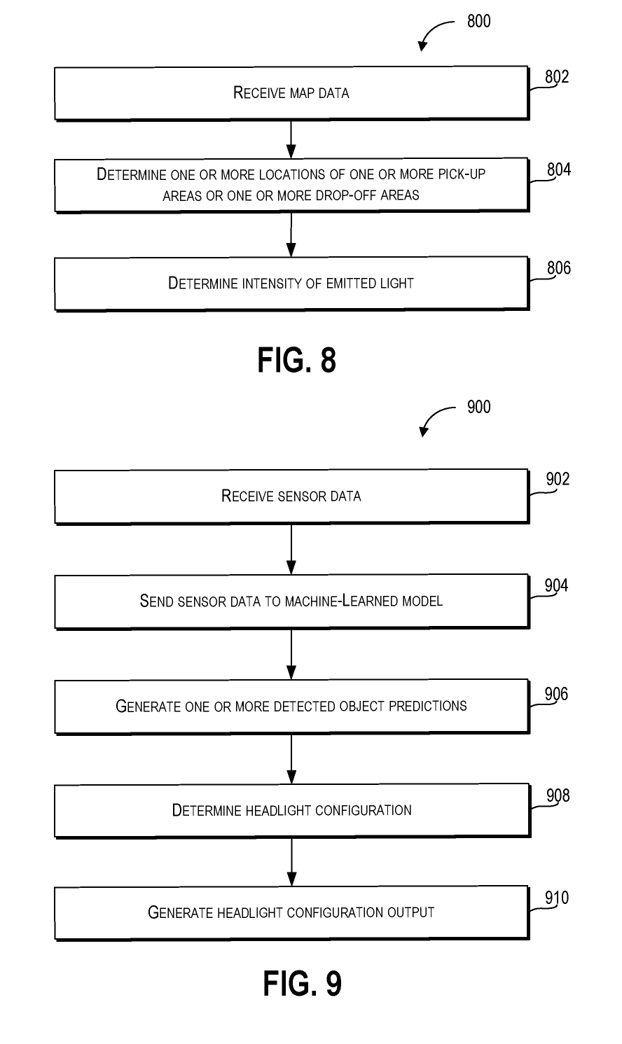

FIG. 8 depicts a flow diagram of an example method of autonomous vehicle operation according to example embodiments of the present disclosure. One or more portions of a method 800 can be implemented by one or more devices (e.g., one or more computing devices) or systems including, for example, the operations computing system 104, the vehicle 108, or the vehicle computing system 112, shown in FIG. 1. Moreover, one or more portions of the method 800 can be implemented as an algorithm on the hardware components of the devices described herein (e.g., as in FIG. 1) to, for example, determine a headlight configuration for a vehicle. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 802, the method 800 can include receiving map data (e.g., the map data 122) including information associated with a plurality of locations, geographical features in an environment (e.g., the environment in the method 600), and/or the weather and/or climactic conditions in the environment (e.g., precipitation, humidity, temperature, snow, cloud conditions, and/or barometric pressure). The vehicle (e.g., the vehicle 108) can receive the map data via one or more signals transmitted from a satellite (e.g., a GPS satellite), a remote computing device including the one or more remote computing devices 106 (e.g., a smartphone transmitting a local map associated with an area proximate to the smartphone's location), an operations center including the operations computing system 104 (e.g., an operations center associated with arranging pick-ups or deliveries for the vehicle), a service depot, and/or one or more other vehicles. The plurality of locations or geographical features can include one or more school locations, one or more residential locations, one or more commercial locations, one or more wildlife locations, one or more tollbooth locations, one or more bridges, one or more tunnels, and/or one or more overpasses. In some embodiments, determining the plurality of spatial relations (e.g., the plurality of spatial relations in the method 600) can include determining the plurality of spatial relations based at least in part on the map data.

At 804, the method 800 can include determining, based at least in part on map data, one or more locations of one or more pick-up areas and/or drop-off areas in the environment. The pick-up areas and the drop-off areas can include areas in which the vehicle can respectively pick-up (e.g., travel to a location at which passengers that are waiting to be picked-up by the vehicle) and/or drop-off passengers (e.g., travel to a location at which passengers in the vehicle will be dropped-off).

At 806, the method 800 can include determining an intensity of emitted light for the one or more headlights (e.g., the one or more headlights 110) based at least in part on a distance of the vehicle (e.g., the vehicle 108) from the one or more pick-up areas or drop-off areas. For example, one or more sensors (e.g., one or more image sensors and/or cameras) of the vehicle can determine the intensity of light in the environment around the vehicle as well the intensity of individual light sources in the environment around the vehicle. By way of example, as the vehicle leaves a drop-off area, the intensity of emitted light for the one or more headlights can be increased so as to provide passengers with a better view of the area around the vehicle when darkness has fallen. In some embodiments, determining the headlight configuration can include determining the headlight configuration based at least in part on the intensity of emitted light for the one or more headlights.

FIG. 9 depicts a flow diagram of an example method of autonomous vehicle operation according to example embodiments of the present disclosure. One or more portions of a method 900 can be implemented by one or more devices (e.g., one or more computing devices) or systems including, for example, the operations computing system 104, the vehicle 108, or the vehicle computing system 112, shown in FIG. 1. Moreover, one or more portions of the method 900 can be implemented as an algorithm on the hardware components of the devices described herein (e.g., as in FIG. 1) to, for example, determine a headlight configuration for a vehicle. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 902, the method 900 can include receiving sensor data (e.g., the sensor data 116) from one or more sensors (e.g., the one or more sensors 114) associated with a vehicle (e.g., the vehicle 108). The sensor data can include information associated with a set of characteristics of one or more objects including a set of physical dimensions of one or more objects, a color of the one or more objects, a velocity of the one or more objects, an acceleration of the one or more objects, and/or one or more sounds associated with the one or more objects (e.g., engine noise).

At 904, the method 900 can include sending the sensor data to a machine-learned model which can include one or more of a machine-learned object detection and prediction model (e.g., the one or more machine-learned models 1130 and/or the one or more machine-learned models 1170). For example, the machine-learned object detection and prediction model can be implemented on a computing system (e.g., the vehicle computing system 112) associated with the vehicle (e.g., the vehicle 108) and can be configured to receive the sensor data via one or more communication networks (e.g., the communication network 102). For instance, the vehicle computing system 112 can include, employ, and/or otherwise leverage a machine-learned object detection and prediction model. The machine-learned object detection and prediction model can be or can otherwise include one or more various models such as, for example, neural networks (e.g., deep neural networks), or other multi-layer non-linear models.

Neural networks can include convolutional neural networks, recurrent neural networks (e.g., long short-term memory recurrent neural networks), feed-forward neural networks, and/or other forms of neural networks. For instance, supervised training techniques can be performed to train the machine-learned object detection and prediction model to detect and/or predict an interaction between one or more headlights (e.g., the one or more headlights 110) and one or more objects; light emitted by the one or more headlights (e.g., the one or more headlights 110) and one or more objects; between a first object (e.g., the vehicle 108) and one or more second objects (e.g., objects external to the vehicle 108); and/or the predicted interaction trajectories associated therewith (e.g., using labeled driving log data, sensor data, state data, with known instances of interactions and/or the resultant trajectories). In some implementations, training data for the machine-learned object detection and prediction model can be based at least in part on the predicted interaction outcomes determined using a rules-based model, that can be used to help train the machine-learned object detection and prediction model to detect and/or predict one or more interactions and/or interaction trajectories including interactions and or interaction trajectories associated with light produced by one or more headlights. Further, the training data can be used to train the machine-learned object detection and prediction model offline.

In some embodiments, the vehicle computing system 112 can input data into the machine-learned object detection and prediction model and receive an output. For instance, the vehicle computing system 112 can obtain data indicative of a machine-learned object detection and prediction model from an accessible memory onboard the vehicle 108 and/or from a memory that is remote from the vehicle 108 (e.g., via a wireless network). The vehicle computing system 112 can provide input data into the machine-learned object detection and prediction model. The input data can include the data associated with one or more headlights, light emitted by the one or more headlights, and the one or more objects including one or more vehicles, pedestrians, cyclists, buildings, and/or environments associated with the one or more objects (e.g., roads, bodies of water, and/or forests). Further, the input data can include data indicative of a headlight configuration for one or more headlights (e.g., the states of the one or more headlights 110), the initial trajectory, state data, sensor data, trajectory/state data of other objects, planned vehicle trajectories, map data, associated with a first object (e.g., the vehicle 108) and/or data indicative of the initial trajectory, state data, sensor data, trajectory/state data of other objects, planned vehicle trajectories, map data, associated with the one or more other objects (e.g., other vehicles on a road with the vehicle 108).

The machine-learned object detection and prediction model can process the input data to predict an interaction associated with an object (e.g., a light-object interaction, an object-object interaction, and/or an object-vehicle interaction). Moreover, the machine-learned object detection and prediction model can predict one or more interactions for an object including the effect of light cast on an object, the effect of light produced by an object, and the trajectory and predicted path of an object based at least in part on the interaction. Further, the vehicle computing system 112 can obtain an output from the machine-learned object detection and prediction model. The output from the machine-learned object detection and prediction model can be indicative of the one or more predicted interactions (e.g., the effect of light cast on an object by the one or more headlights 110 and/or the effect of light cast on the vehicle 108 by one or more headlights of other objects) and/or trajectories of an object within the surrounding environment (e.g., the path of a vehicle external to the vehicle 108). For example, the output can be indicative of the one or more predicted interactions and/or interaction trajectories of one or more objects within an environment. In some implementations, the vehicle computing system 112 can provide input data indicative of the predicted interaction and the machine-learned object detection and prediction model can output the predicted interactions based on such input data. In some implementations, the output can also be indicative of a probability associated with each respective interaction.

At 906, the method 900 can include generating, based at least in part on the output from the machine-learned object detection and prediction model, one or more detected object predictions including one or more identities associated with the one or more objects. For example, the machine-learned object detection and prediction model can classify and/or identify the one or more objects based in part on a comparison of the sensor data to one or more previously classified objects.

At 908, the method 900 can include generating, based at least in part on the one or more identities associated with the one or more object predictions, a headlight configuration associated with one or more states of one or more headlights (e.g., the one or more headlights 110) of a vehicle (e.g., the vehicle 108). The headlight configuration can specify one or more headlight states for each of the one or more headlights. In some embodiments, the headlight configuration can be stored in one or more memory devices that include one or more datasets or data structures associated with the headlight configuration and which can be retrieved for later use. Further, in some embodiments, the machine-learned object detection and prediction model can be trained to associate the headlight configuration with the one or more identities associated with the one or more object predictions. For example, the vehicle can generate a headlight configuration in which the front headlights of the vehicle are dimmed when pedestrians are detected within a predetermined proximity distance of the vehicle.

At 910, the method 900 can include generating a headlight configuration output based at least in part on the headlight configuration. The headlight configuration output can include one or more indications associated with the headlight configuration. The headlight configuration output can include one or more data structures that include various specifications of the headlight configuration (e.g., which headlights to activate and/or headlight intensity) are transmitted to one or more vehicle systems including one or more headlights and/or other lighting systems of the vehicle.

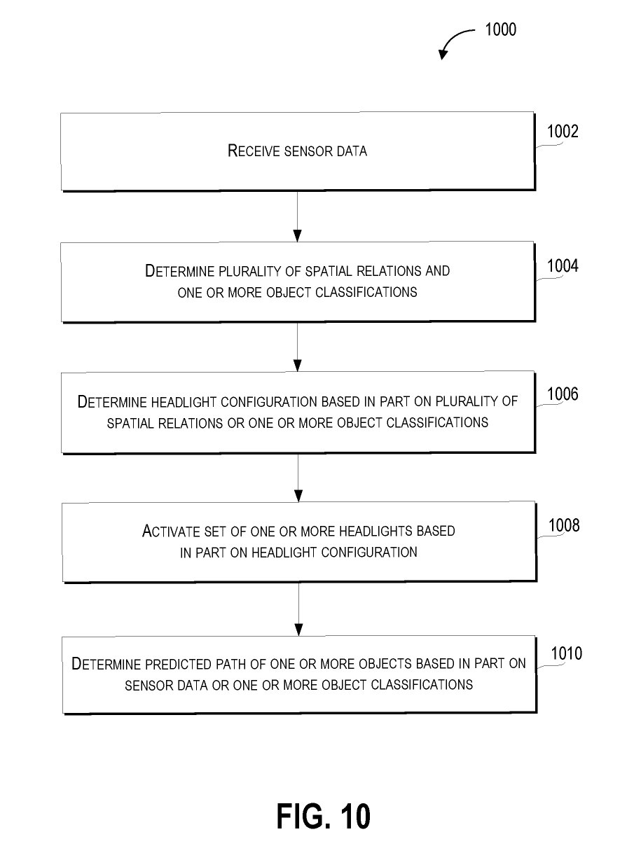

FIG. 10 depicts a flow diagram of an example method of autonomous vehicle operation according to example embodiments of the present disclosure. One or more portions of a method 1000 can be implemented by one or more devices (e.g., one or more computing devices) or systems including, for example, the operations computing system 104, the vehicle 108, or the vehicle computing system 112, shown in FIG. 1. Moreover, one or more portions of the method 1000 can be implemented as an algorithm on the hardware components of the devices described herein (e.g., as in FIG. 1) to, for example, determine a headlight configuration for a vehicle. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 1002, the method 1000 can include receiving sensor data (e.g., the sensor data 116) based at least in part on one or more sensor outputs from one or more sensors (e.g., the one or more sensors 114) of a vehicle (e.g., the vehicle 108). The one or more sensor outputs can be based at least in part on a state of the vehicle and an environment comprising one or more objects. For example, a vehicle can receive sensor data from one or more LIDAR devices mounted on the roof of the vehicle, which can be used to determine the location of one or more objects detectable by the LIDAR.

The state of the vehicle can include at least one of a velocity of the vehicle, an acceleration of the vehicle, a geographical location of the vehicle, orientation, bearing, and/or a trajectory of the vehicle. The one or more sensors can include at least one of one or more cameras, one or more sonar devices, one or more radar devices, one or more light detection and ranging (LIDAR) devices, one or more thermal sensors, one or more audio sensors, one or more tactile sensors, one or more humidity sensors, one or more pressure sensors, and/or one or more barometric pressure sensors.

At 1004, the method 1000 can include determining, based at least in part on the sensor data and a machine-learned model (e.g., the one or more machine-learned models 1130 and/or the one or more machine-learned models 1170), a plurality of spatial relations and one or more object classifications corresponding to the one or more objects. The plurality of spatial relations can include a distance between the vehicle and each of the one or more objects. Further, the plurality of spatial relations can include a height of the one or more objects with respect to the vehicle. The one or more object classifications can be based on actual objects including one or more vehicles (e.g., automobiles, buses, motorcycles), one or more pedestrians, one or more cyclists, domesticated animals (e.g., dogs and/or cats), wildlife (e.g., deer, moose and/or bears), one or more buildings (e.g., office buildings, apartment buildings, and/or parking structures), one or more reflective surfaces (e.g., mirrors, glass windows, and/or chrome automobile bumpers), and/or one or more utility structures (e.g., telephone poles and/or fire hydrants).

At 1006, the method 1000 can include determining, based at least in part on the plurality of spatial relations or the one or more object classifications, a headlight configuration for one or more headlights (e.g., the one or more headlights 110) of the vehicle (e.g., the vehicle 108). The headlight configuration can specify one or more headlight states for each of the one or more headlights. For example, based on the determination that the one or more objects include a pedestrian standing at an intersection, the vehicle can generate a headlight configuration in which the state of the headlights includes a reduced intensity of light emitted by the headlights that are directed towards the pedestrian, while leaving other headlights on at full intensity.

At 1008, the method 1000 can include activating a set of the one or more headlights based at least in part on the headlight configuration. For example, a headlight configuration data object can indicate that all eight of a vehicle's front headlights are to be turned ten degrees to the right in order to better illuminate a curving road being traversed by the vehicle. Based in part on receiving one or more signals or data that include the headlight configuration data object, the vehicle can activate all eight of the front headlights and turn the eight headlights ten degrees to the right.

At 1010, the method 1000 can include determining, based at least in part on the sensor data or the one or more object classifications, one or more predicted paths of the one or more objects. The one or more predicted paths can include a set of locations each of the one or more objects is determined to traverse. The headlight configuration can be based at least in part on the one or more predicted paths of the one or more objects. For example, two detected objects can be determined to be a motor vehicle and a cyclist. Based on the determination that the two objects are a motor vehicle and a cyclist, the vehicle computing system can determine a maximum velocity range (e.g., the motor vehicle can have a maximum velocity of two hundred kilometers per hour and the cyclist can have a maximum velocity on flat ground of sixty kilometers per hour) for each of the two objects and thereby more accurately determine the path of each of the two objects.

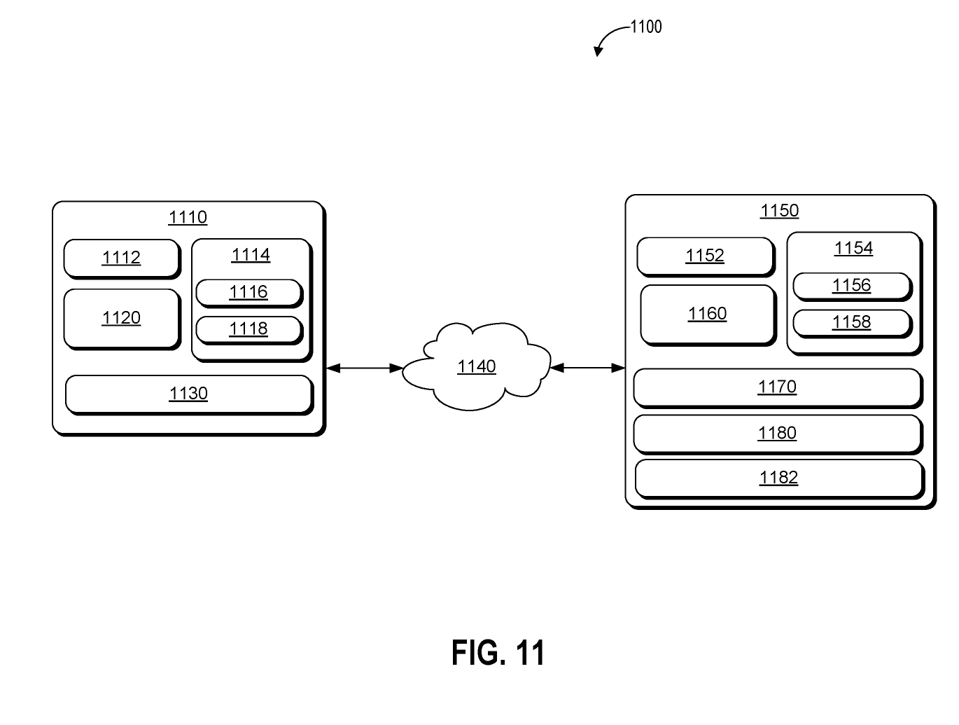

FIG. 11 depicts a block diagram of an example computing system 1100 according to example embodiments of the present disclosure. The example system 1100 includes a computing system 1110 and a machine learning computing system 1150 that are communicatively coupled over one or more networks 1140.

In some implementations, the computing system 1110 can perform various operations including the determination of a headlight configuration for a vehicle (e.g., the vehicle 108) and/or the determination of a state of an object (e.g., an object proximate to the vehicle) including the object's physical dimensions, location, position, orientation, velocity, acceleration, shape, and/or color. In some implementations, the computing system 1110 can be included in an autonomous vehicle. For example, the computing system 1110 can be on-board the autonomous vehicle. In other implementations, the computing system 1110 is not located on-board the autonomous vehicle. For example, the computing system 1110 can operate offline to determine a headlight configuration for a vehicle (e.g., the vehicle 108) and/or determine an object's state including the object's physical dimensions, location, position, path, orientation, velocity, acceleration, shape, and/or color. The computing system 1110 can include one or more distinct physical computing devices.

The computing system 1110 includes one or more processors 1112 and a memory 1114. The one or more processors 1112 can be any suitable processing device (e.g., a processor core, a microprocessor, an ASIC, a FPGA, a controller, and/or a microcontroller) and can be one processor or a plurality of processors that are operatively connected. The memory 1114 can include one or more non-transitory computer-readable storage media, such as RAM, ROM, EEPROM, EPROM, one or more memory devices, flash memory devices, and/or combinations thereof.

The memory 1114 can store information that can be accessed by the one or more processors 1112. For instance, the memory 1114 (e.g., one or more non-transitory computer-readable storage mediums, memory devices) can store data 1116 that can be obtained, received, accessed, written, manipulated, created, and/or stored. The data 1116 can include, for instance, data associated with the determination of a headlight configuration for a vehicle as described herein. In some implementations, the computing system 1110 can obtain data from one or more memory devices that are remote from the system 1110.

The memory 1114 can also store computer-readable instructions 1118 that can be executed by the one or more processors 1112. The instructions 1118 can be software written in any suitable programming language or can be implemented in hardware. Additionally, or alternatively, the instructions 1118 can be executed in logically and/or virtually separate threads on the one or more processors 1112.

For example, the memory 1114 can store instructions 1118 that when executed by the one or more processors 1112 cause the one or more processors 1112 to perform any of the operations and/or functions described herein, including, for example, determining a headlight configuration for a vehicle (e.g., the vehicle 108) and/or determining a state of an object (e.g., an object proximate to the vehicle) including the object's physical dimensions, location, position, orientation, velocity, acceleration, shape, and/or color.

According to an aspect of the present disclosure, the computing system 1110 can store or include one or more machine-learned models 1130. As examples, the one or more machine-learned models 1130 can be or can otherwise include various machine-learned models such as, for example, neural networks (e.g., deep neural networks), support vector machines, decision trees, ensemble models, k-nearest neighbors models, Bayesian networks, or other types of models including linear models and/or non-linear models. Example neural networks include feed-forward neural networks, recurrent neural networks (e.g., long short-term memory recurrent neural networks), convolutional neural networks, or other forms of neural networks.

In some implementations, the computing system 1110 can receive the one or more machine-learned models 1130 from the machine learning computing system 1150 over the one or more networks 1140 and can store the one or more machine-learned models 1130 in the memory 1114. The computing system 1110 can then use or otherwise implement the one or more machine-learned models 1130 (e.g., by the one or more processors 1112). In particular, the computing system 1110 can implement the machine-learned models 1130 to determine a headlight configuration for a vehicle (e.g., the vehicle 108) and/or determining a state of an object (e.g., an object proximate to the vehicle) including the object's physical dimensions, location, position, orientation, velocity, acceleration, shape, and/or color.

The machine learning computing system 1150 includes one or more processors 1152 and a memory 1154. The one or more processors 1152 can be any suitable processing device (e.g., a processor core, a microprocessor, an ASIC, a FPGA, a controller, and/or a microcontroller) and can be one processor or a plurality of processors that are operatively connected. The memory 1154 can include one or more non-transitory computer-readable storage media, such as RAM, ROM, EEPROM, EPROM, one or more memory devices, flash memory devices, and/or combinations thereof.

The memory 1154 can store information that can be accessed by the one or more processors 1152. For instance, the memory 1154 (e.g., one or more non-transitory computer-readable storage mediums, memory devices) can store data 1156 that can be obtained, received, accessed, written, manipulated, created, and/or stored. The data 1156 can include, for instance, determining a headlight configuration for an autonomous vehicle as described herein. In some implementations, the machine learning computing system 1150 can obtain data from one or more memory devices that are remote from the system 1150.

The memory 1154 can also store computer-readable instructions 1158 that can be executed by the one or more processors 1152. The instructions 1158 can be software written in any suitable programming language or can be implemented in hardware. Additionally, or alternatively, the instructions 1158 can be executed in logically and/or virtually separate threads on the one or more processors 1152.

For example, the memory 1154 can store instructions 1158 that when executed by the one or more processors 1152 cause the one or more processors 1152 to perform any of the operations and/or functions described herein, including, for example, determining a headlight configuration for a vehicle (e.g., the vehicle 108) and/or determining a state of an object (e.g., an object proximate to the vehicle) including the object's physical dimensions, location, position, orientation, velocity, acceleration, shape, and/or color.

In some implementations, the machine learning computing system 1150 includes one or more server computing devices. If the machine learning computing system 1150 includes multiple server computing devices, such server computing devices can operate according to various computing architectures, including, for example, sequential computing architectures, parallel computing architectures, or some combination thereof.

In addition or alternatively to the one or more machine-learned models 1130 at the computing system 1110, the machine learning computing system 1150 can include one or more machine-learned models 1170. As examples, the machine-learned models 1170 can be or can otherwise include various machine-learned models such as, for example, neural networks (e.g., deep neural networks), support vector machines, decision trees, ensemble models, k-nearest neighbors models, Bayesian networks, or other types of models including linear models and/or non-linear models. Example neural networks include feed-forward neural networks, recurrent neural networks (e.g., long short-term memory recurrent neural networks), convolutional neural networks, or other forms of neural networks.

As an example, the machine learning computing system 1150 can communicate with the computing system 1110 according to a client-server relationship. For example, the machine learning computing system 1170 can implement the machine-learned models 1170 to provide a web service to the computing system 1110. For example, the web service can provide determining a headlight configuration for a vehicle (e.g., the vehicle 108) and/or determining a state of an object (e.g., an object proximate to the vehicle) including the object's physical dimensions, location, position, path, orientation, velocity, acceleration, shape, and/or color.

Thus, machine-learned models 1130 can located and used at the computing system 1110 and/or machine-learned models 1170 can be located and used at the machine learning computing system 1150.

In some implementations, the machine learning computing system 1150 and/or the computing system 1110 can train the machine-learned models 1130 and/or 1170 through use of a model trainer 1180. The model trainer 1180 can train the machine-learned models 1130 and/or 1170 using one or more training or learning algorithms. One example training technique is backwards propagation of errors. In some implementations, the model trainer 1180 can perform supervised training techniques using a set of labeled training data. In other implementations, the model trainer 1180 can perform unsupervised training techniques using a set of unlabeled training data. The model trainer 1180 can perform a number of generalization techniques to improve the generalization capability of the models being trained. Generalization techniques include weight decays, dropouts, or other techniques.

In particular, the model trainer 1180 can train a machine-learned model 1130 and/or 1170 based on a set of training data 1182. The training data 1182 can include, for example, a plurality of objects including vehicle objects, pedestrian objects, cyclist objects, building objects, and/or road objects, which can be associated with various characteristics and/or properties (e.g., physical dimensions, velocity, and/or travel path). The model trainer 1180 can be implemented in hardware, firmware, and/or software controlling one or more processors.

The computing system 1110 can also include a network interface 1120 used to communicate with one or more systems or devices, including systems or devices that are remotely located from the computing system 1110. The network interface 1120 can include any devices, circuits, components, and/or software, for communicating with one or more networks (e.g., the one or more networks 1140). In some implementations, the network interface 1120 can include, for example, one or more of a communications controller, receiver, transceiver, transmitter, port, conductors, software and/or hardware for communicating data. Similarly, the machine learning computing system 1150 can include a network interface 1160.

The one or more networks 1140 can be any type of network or combination of networks that allows for communication between devices. In some embodiments, the one or more networks 1140 can include one or more of a local area network, wide area network, the Internet, secure network, cellular network, mesh network, peer-to-peer communication link and/or some combination thereof and can include any number of wired or wireless links. Communication over the one or more networks 1140 can be accomplished, for instance, via a network interface using any type of protocol, protection scheme, encoding, format, and/or packaging.

FIG. 11 illustrates one example computing system 1100 that can be used to implement the present disclosure. Other computing systems can be used as well. For example, in some implementations, the computing system 1110 can include the model trainer 1180 and the training dataset 1182. In such implementations, the machine-learned models 1130 can be both trained and used locally at the computing system 1110. As another example, in some implementations, the computing system 1110 is not connected to other computing systems.

In addition, components illustrated and/or discussed as being included in one of the computing systems 1110 or 1150 can instead be included in another of the computing systems 1110 or 1150. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method of autonomous vehicle operation, the computer-implemented method comprising:
receiving, by a computing system comprising one or more computing devices, sensor data based at least in part on one or more sensor outputs from one or more sensors of an autonomous vehicle, the one or more sensor outputs based at least in part on a state of the autonomous vehicle and an environment comprising one or more objects;
determining, by the computing system, based at least in part on the sensor data, a plurality of spatial relations comprising a position of the autonomous vehicle with respect to the one or more objects;
determining, by the computing system, based at least in part on the plurality of spatial relations, a headlight configuration for one or more headlights of the autonomous vehicle, the headlight configuration specifying one or more headlight states for each of the one or more headlights; and
activating, by the computing system, a set of the one or more headlights based at least in part on the headlight configuration.

2. The computer-implemented method of claim 1, wherein the one or more headlight states comprise at least one of an on state, an off state, a target illumination region, a horizontal angle, a vertical angle, a height, an intensity of emitted light, or a color of emitted light.

3. The computer-implemented method of claim 1, further comprising:
determining, by the computing system, based at least in part on the plurality of spatial relations, an object proximity distance comprising a distance between the autonomous vehicle and one of the one or more objects that is closest to the autonomous vehicle, and
wherein determining the headlight configuration further comprises determining, by the computing system, based at least in part on the object proximity distance, an intensity of emitted light for at least one of the one or more headlights.

4. The computer-implemented method of claim 3, wherein the intensity of emitted light is proportional to the object proximity distance.

5. The computer-implemented method of claim 1, further comprising:
determining, by the computing system, based at least in part on path data or the sensor data, a predicted path of the autonomous vehicle, the path data comprising information associated with a plurality of locations for the autonomous vehicle to traverse, the plurality of locations comprising a current location of the autonomous vehicle and a destination location, and
wherein determining the headlight configuration further comprises determining the headlight configuration based at least in part on the predicted path of the autonomous vehicle.

6. The computer-implemented method of claim 5, further comprising:
determining, by the computing system, based at least in part on the plurality of spatial relations, one or more path characteristics of the predicted path of the autonomous vehicle, the one or more path characteristics comprising at least one of a path angle, a path grade, or an intersection proximity,
wherein determining the headlight configuration further comprises determining the headlight configuration based at least in part on the one or more path characteristics.

7. The computer-implemented method of claim 1, further comprising:
determining, by the computing system, based at least in part on the sensor data, one or more predicted object paths of the one or more objects, the one or more predicted object paths comprising a plurality of locations that each of the one or more respective objects is determined to traverse,
wherein determining the headlight configuration further comprises determining the headlight configuration based at least in part on the one or more predicted object paths of the one or more objects.

8. The computer-implemented method of claim 1, further comprising:
determining, by the computing system, based at least in part on the sensor data, a location of one or more reflective surfaces in the environment,
wherein determining the headlight configuration further comprises determining the headlight configuration based at least in part on the location of the one or more reflective surfaces.

9. The computer-implemented method of claim 1, further comprising:
receiving, by the computing system, external vehicle configuration data associated with at least one of a location, a velocity, a travel path, external vehicle sensor outputs, or an external vehicle headlight configuration of one or more vehicles in the environment,
wherein determining the headlight configuration further comprises determining the headlight configuration based at least in part on the external vehicle configuration data.

10. The computer-implemented method of claim 1, further comprising:
receiving, by the computing system, map data comprising information associated with a plurality of locations or geographical features in the environment,
wherein determining the plurality of spatial relations comprises determining the plurality of spatial relations based at least in part on the map data.

11. The computer-implemented method of claim 10, further comprising:
determining, by the computing system, based at least in part on map data, one or more locations of one or more pick-up areas or drop-off areas in the environment; and
determining, by the computing system, an intensity of emitted light for the one or more headlights based at least in part on a distance of the autonomous vehicle from the one or more pick-up areas or drop-off areas,
wherein determining the headlight configuration further comprises determining the headlight configuration based at least in part on the intensity of emitted light for the one or more headlights.

12. The computer-implemented method of claim 10, wherein the plurality of locations or geographical features comprises one or more school locations, one or more residential locations, one or more commercial locations, one or more wildlife locations, one or more tollbooth locations, one or more bridges, one or more tunnels, or one or more overpasses.

13. The computer-implemented method of claim 1, wherein the state of the autonomous vehicle comprises at least one of a velocity of the autonomous vehicle, an acceleration of the autonomous vehicle, a geographical location of the autonomous vehicle, or a trajectory of the autonomous vehicle.

14. The computer-implemented method of claim 1, wherein the one or more sensors comprise at least one of one or more cameras, one or more sonar devices, one or more radar devices, one or more light detection and ranging (LIDAR) devices, one or more thermal sensors, one or more audio sensors, one or more tactile sensors, one or more humidity sensors, one or more pressure sensors, or one or more barometric pressure sensors.

15. A computing system, comprising:
one or more processors;
a machine-learned object detection model trained to receive sensor data and, responsive to receiving the sensor data, generate an output comprising one or more detected object predictions and a headlight configuration based at least in part on the one or more detected object predictions;
a memory comprising one or more computer-readable media, the memory storing computer-readable instructions that when executed by the one or more processors cause the one or more processors to perform operations comprising:
receiving sensor data from one or more sensors associated with an autonomous vehicle, wherein the sensor data comprises information associated with a set of physical dimensions of one or more objects;
sending the sensor data to the machine-learned object detection model; and
generating, based at least in part on the output from the machine-learned object detection model, one or more detected object predictions comprising one or more identities associated with the one or more objects; and
generating, based at least in part on the one or more identities associated with the one or more object predictions, a headlight configuration associated with one or more states of one or more headlights of an autonomous vehicle.

16. The computing system of claim 15, further comprising:
generating a headlight configuration output based at least in part on the headlight configuration, wherein the headlight configuration output comprises one or more indications associated with the headlight configuration.

17. An autonomous vehicle comprising:
one or more processors;
a memory comprising one or more computer-readable media, the memory storing computer-readable instructions that when executed by the one or more processors cause the one or more processors to perform operations comprising:
receiving sensor data based at least in part on one or more sensor outputs from one or more sensors of an autonomous vehicle, wherein the one or more sensor outputs are based at least in part on a state of the autonomous vehicle and an environment comprising one or more objects;
determining, based at least in part on the sensor data and a machine-learned model, a plurality of spatial relations and one or more object classifications corresponding to the one or more objects, wherein the plurality of spatial relations comprises a distance between the autonomous vehicle and each of the one or more objects; and
determining, based at least in part on the plurality of spatial relations or the one or more object classifications, a headlight configuration for one or more headlights of the autonomous vehicle, the headlight configuration specifying one or more headlight states for each of the one or more headlights.

18. The autonomous vehicle of claim 17, further comprising:
activating a set of the one or more headlights based at least in part on the headlight configuration.

19. The autonomous vehicle of claim 17, wherein the one or more object classifications comprise one or more vehicles, one or more pedestrians, one or more cyclists, wildlife, one or more buildings, one or more reflective surfaces, or one or more utility structures.

20. The autonomous vehicle of claim 17, further comprising:
determining, based at least in part on the sensor data or the one or more object classifications, one or more predicted paths of the one or more objects, the one or more predicted paths comprising a set of locations each of the one or more objects is determined to traverse, wherein the headlight configuration is based at least in part on the one or more predicted paths of the one or more objects.
